(19) United States
(12) Patent Application Publication
(10) Pub. No.: US 2015/0165756 A1
(43) Pub. Date: Jun. 18, 2015

(54) STENCILS

(71) Applicant: DTG International GmbH, Zurich (CH)

(72) Inventor: Michael Zahn, Singapore (DE)

(21) Appl. No.: 14/368,242

(22) PCT Filed: Dec. 20, 2012
(86) PCT No.: PCT/EP2012/076489

§ 371 Date: Jun. 23, 2014

Related U.S. Application Data
(60) Provisional application No. 61/579,766, filed on Dec. 23, 2011.

(51) Int. Cl. B41F 15/34

(52) U.S. Cl. CPC B41F 15/34

(57) ABSTRACT

Liquid pharmaceutical composition comprising at least a substituted pyrazolo[1,5-a]pyrimidine compound (P) or a pharmaceutically acceptable salt or a stereoisomeric form thereof, water and at least one pharmaceutically acceptable oily component (C), and optionally one or several further components (F), such as an emulsifier are particularly stable for long time.

The present invention relates to liquid (or semi solid) pharmaceutical compositions containing at least one pyrazolopyrimidine derivative and at least one oily component. The invention also deals with processes for the preparation and testing of such liquid pharmaceutical compositions, in particular emulsions, containing at least one pyrazolopyrimidine derivative, water and an oily component. The invention also relates to different medical uses of these liquid pharmaceutical compositions.

Many heterocyclic drug compounds have lipophilic (hydrophobic) properties and are only sparingly or negligibly water-soluble. The poor water-solubility of these compounds often result in major difficulties in pharmaceutical formulation of these drugs, particularly when stable emulsions for intravenous applications are needed. These formulations however often have to be stable over long time and even at elevated temperatures.

Various approaches for preparing pharmaceutical compositions of sparingly or poorly water-soluble drugs are described in the literature. These methods include physio-chemical solubilization techniques, e.g. micellar solubilization, the use of surface-active agents in the liquid pharmaceutical compositions, formation of complexes of the drug compound, preparation of solid solutions and solid dispersions by means of the use of suitable polymers, use of co-solvent systems and use of the formation of complexes by addition of chelating agents, such as citric acid, tartaric acid, amino acids, thioglycolic acid, and edetate sodium (EDTA). Other approaches are the use of buffering agents, such as acetate, citrate, glutamate and phosphate salts. However, some of these components mentioned, such as solvents, cosolvents and chelating agents, can have adverse effects.

Each of the methods described has inherent limitations, which do not allow their use for parenteral application.

Pharmaceutical emulsions containing a pyrazolopyrimidine compound are heterogeneous systems consisting of at least two liquids which are normally not miscible or which have a limited miscibility with one another. One phase can be described as hydrophilic phase, one phase can be described as lipophilic phase.

A pharmaceutical emulsion is a disperse system, where by applying certain levels of energy one of the two liquids is dispersed in the form of very fine droplets (dispersed phase) in the other liquid (continuous phase).

If, for example, the main liquid component is water (hydrophilic phase) and the other liquid is an oily component (hydrophobic phase), then an oil-in-water (or water-in-oil emulsion) is formed. In order to achieve a stable disperse system in which the oily phase is permanently dispersed in the water phase, it is normally necessary to add one or several emulsifiers, which are interface-active substances.

Emulsifiers normally have an amphiphilic molecular structure, consisting of a hydrophilic and a lipophilic molecular moiety, which are often separated from one and another by a spacer unit. In a classical emulsion, finely disperse droplets of the oily phase, surrounded by an emulsifier shell, are present in the aqueous phase. Emulsifiers lower the surface tension or surface energy between the two phases by positioning themselves at the interface between the two liquids. At the phase boundary, they form an oil/water interfacial film which prevents irreversible coalescence of the droplets. Pharmaceutical emulsions are frequently stabilized by natural or synthetic emulsifiers or mixtures thereof. Emulsifiers can traditionally be divided into ionic emulsifiers and non-ionic emulsifiers. One example of an anionic emulsifier is regular soap, examples of cationic emulsifiers are quaterny ammonium compounds. The hydrophilic part of the molecule of non-ionic emulsifiers frequently consists of glycerol, polyglycerol, sorbitants, carbohydrates and/or polyoxyethylene glycols. In many cases, this hydrophilic moiety is linked to the lipophilic molecular moiety via an ester or ether group. The lipophilic part of the molecule usually consists e.g. of fatty alcohols, fatty acids or isofatty acids. By varying the structure and the size of the polar and non-polar molecular parts and of the spacer part, the lipophilicity and the hydrophilicity of the emulsifier can be varied. This characteristic of the emulsifier is expressed as its HLB value.

Whereas many pharmaceutical emulsions can be stabilized by using classical emulsifiers, certain types of emulsions containing active ingredients with poor solubility in water, can until now not be stabilized as long as needed. One decisive factor for the stability of pharmaceutical emulsions is the choice of type of emulsifier and the concentration of emulsifier used in the system. The characteristics and concentrations of all substances present in the system have to be taken into consideration.

By using the appropriate emulsifier the coalescence of the disperse phase as well as other types of instability such as creaming and sedimentation can be prevented. If the density of the aqueous phase is higher than that of the oily component, after a certain period of time a separation of the phases is often detected.

It is one object of this invention to provide with a method for stabilization of aqueous pharmaceutical compositions, particularly of emulsions containing an aqueous phase and an oily phase, which contains a pyrazolopyrimidin compound.

Various types of pyrazolopyrimidine derivatives have been described in recent literature. For example, different types of substituted pyrazolo[1,5-a]pyrimidines compounds and formulations containing these compounds have been disclosed in WO 2008/015269, WO 2008/015270, WO 2008/015271, WO 2009/095253, WO 2009/095254 and WO 2007/006530, wherein the pyrazolo[1,5-a]pyrimidines disclosed are negative modulators of the known receptor mGluR5. In WO 2004/087153 pyrazolopyrimidines are described, which can act as small molecule immune potentiators (SMIP) and which can be used e.g. for cancer treatment. JP-A 2002/212075 discloses oil-in-water lipid microspheres comprising a phenyl-group containing pyrazolopyrimidine compound.

In WO 2004/089471, the use of substituted pyrazolo[1,5-a]pyrimidines for the treatment of diseases is described where it is desirable to inhibit the enzyme 11βHSD1. In WO 2003/037900, further specific pyrazolopyrimidine compounds are described as inhibitors of ion-channels in human cells. In WO 2003/101993 several types of pyrazolopyrimidine compounds and their use for the treatment of hepatitis infections are disclosed. In WO 2003/091256 pyrazolopyrimidine derivatives which have a NADPH-oxidase inhibitor activity are described. In the application WO 2008/015269 pyrazolo[1,5-a]pyrimidine derivatives are disclosed, which are linked to a heterocyclic amine and which are potent modulators of the receptor mGluR5. WO 2011/064237 describes crystalline forms of a specific pyrazolopyrimidine compound.

Many pyrazolo[1,5-a]pyrimidine derivatives have a low solubility in water, e. g. lower than 0.1 mg per ml of water (at 20° C.). Furthermore, the wettability of many pyrazolo[1,5-a]-pyrimidine derivatives is very low (measured by contact angles theta >>90°), so that the preparation of aqueous compositions is difficult and time consuming.

As lipophilic pharmaceutical compounds, the pyrazolo[1,5-a]pyrimidine derivatives of the invention often exhibit an octanol/water partition coefficient of log P greater than 1, in particular from 2 to 5, often from 3 to 4. The lipophilicity of a compound can in general be expressed by the log P or log D value. A high log P value describes lipophilic compounds and a low value describes hydrophilic compounds.

The octanol/water partition coefficient (log P) of the compounds tested according to this invention can e.g. be determined by accepted standard methods, such as OECD guideline (July 1995), “Test No. 107: Partition Coefficient (n-octanol/water): Shake Flask Method”, OECD Guidelines for the Testing of Chemicals, Section 1: Physical-Chemical properties, OECD Publishing. The log P value may also be determined according to the Draft OECD guideline OECD (2000), see OECD Draft guideline for the Testing of Chemicals: 122 Partition Coefficient (n-Octanol/Water): pH-Metric Method for Ionisable Substances.

Liquid pharmaceutical compositions containing pyrazolo[1,5-a]pyrimidine derivatives often are difficult to prepare and/or are not stable during storage, in particular when formulated as aqueous preparations. The stability of the liquid pharmaceutical composition containing the pyrazolo[1,5-a]pyrimidine should however be at least for 9 months (at 25° C.), preferably for at least 12 months. Furthermore, for parenteral pharmaceutical applications, the amount of pyrazolo[1,5-a]pyrimidine derivative needed at the specific site of action is often higher than conventional pharmaceutical formulations can provide with.

In particular, the pyrazolo[1,5-a]pyrimidine derivatives substituted with an isoquinoline substituent are molecules with a very low aqueous solubility of e. g. only 2 to 50 microgram per milliliter. The solubility in aqueous media often cannot be improved by the adjustment of pH-value, as many of these pyrazolo[1,5-a]pyrimidine derivatives have no relevant basic or acidic groups.

One known way of improving solubility of drug compounds is the use of a solvent (such as water) in combination with one or several co-solvents. However, the toxicological impact of these excipients in the requested amounts can be a disadvantage. Alternative formulations use the lipophilicity of the compounds to dissolve them in oils, fats and waxes to develop “oily solutions” and related formulations like emulsions for oral and parenteral applications. Some classical disadvantages of these formulations are their high calorimetric input, their unpleasant mouth-feel and taste and also limitations to increase the solubility of the compounds.

Solvents (such as water) and co-solvents (such as DMSO or glycerol) can be used in combination to prepare solutions comprising pyrazolo[1,5-a]pyrimidine compounds. However, only limited amounts of these co-solvents can be used in medicinal products for experimental preclinical and clinical studies, due to safety and tolerability reasons. The acceptable amounts are even lower for marketed drug products for acute and chronic applications in humans.

One other way of improving solubility is the use of surfactants to design aqueous based solutions for pharmaceutical applications. This can also lead to an improvement of the solubility of pyrazolopyrimidines. However, the toxicological acceptance of surfactants in human used drug products for acute and chronic use can be limited, the challenges and limitations are similar to those of co-solvent based approaches.

Therefore, the development of liquid formulations, in particular of aqueous based formulations, for various types of substituted pyrazolo[1,5-a]pyrimidines and for different application routes is a challenging task. The liquid pharmaceutical compositions should provide with pharmacologically active and well tolerated concentrations of the pyrazolo[1,5-a]-pyrimidine compounds.

### DETAILED DESCRIPTION

The hydrophobic small molecules of substituted pyrazolo[1,5-a]pyrimidine derivatives (P) were found to be solubilised by the use of an oily component (C), which can consist of one or several lipophilic components. The pharmaceutical compositions of this invention often comprise a pyrazolo[1,5-a]pyrimidine derivative which has a molecular weight between 200 and 800 g/mol.

The invention relates to a liquid (or semi solid) pharmaceutical composition comprising water, at least one pyrazolo-[1,5-a]pyrimidine compound (P) or a pharmaceutically acceptable salt or a stereoisomeric form thereof, and at least one pharmaceutically acceptable oily component (C), and optionally one or several further components (F). The compositions are preferably liquid compositions. These compositions are preferably for parenteral applications, such as injections or infusions.

The further component(s) (F) can e.g. be a pharmaceutical additive from the group of emulsifiers (e.g. a lecithine or a phosphatidyl choline), pH-regulators and buffering agents (e.g. sodium hydroxide), emulsifiers (e.g. salt of oleic acid) and compounds for regulation of the tonicity (e.g. glycerol).

The invention relates to a liquid (or semi solid) pharmaceutical composition comprising water, at least one pyrazolo-[1,5-a]pyrimidine compound (P) or a pharmaceutically acceptable salt or a stereoisomeric form thereof, and at least two different pharmaceutically acceptable oily components (C), and one or several further components (F).

The invention in particular relates to a liquid (or semi solid) pharmaceutical composition comprising (or consisting of):
at least one pyrazolo[1,5-a]pyrimidine compound (P) of formula (I)

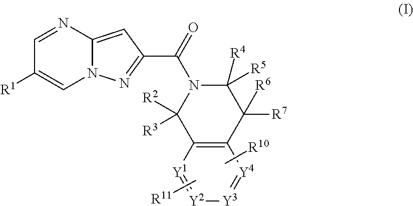

wherein
Y¹ represents N or C—,
Y² represents N or C—,
Y³ represents N or C—,
Y⁴ represents N or C—,
   wherein at least two of the groups Y¹ to Y⁴ denote a carbon atom, (often all four groups Y¹ to Y⁴ denote carbon atoms),
R¹ represents chloro or bromo;
R² and R³ each independently represent hydrogen, C₁₋₃ alkyl, C₃₋₆ cycloalkyl or trifluoromethyl;
R⁴ and R⁵ each independently represent hydrogen, C₁₋₃ alkyl, C₃₋₆cycloalkyl or trifluoromethyl;
R⁶ and R⁷ independently represent hydrogen, C₁₋₃-alkyl, C₃₋₆cycloalkyl or trifluoromethyl;
R¹⁰ and R¹¹ independently represent hydrogen, halogen, amino, hydroxy, nitro, cyano, trifluoromethyl, trifluoromethoxy, C₁-C₃alkyl, C₁-C₃alkyloxy, cyclohexyl, phenyl, or a ring system radical from the group: furanyl, thienyl, pyrrolyl, oxazolyl, isoxazolyl, isothiazolyl, oxadiazolyl, triazolyl, thiadiazolyl, thiazolyl, imidazolyl, oxadiazolyl, tetrazolyl, pyridinyl, pyrimidinyl, pyridazinyl, pyrazinyl, triazinyl, pyrazolyl, benzofiuryl, benzothienyl, indolyl, indolizinyl, isoindolyl, indolinyl, indazolyl, benzimidazolyl, benzoxazolyl, benzothiazolyl, quinolinyl, quinazolinyl, quinoxalinyl, cinnolinyl, naphtyridinyl and isoquinolinyl;
or R¹⁰ and R¹¹ together with the two carbon atoms carrying them represent a heteroaryl having 5 or 6 ring members or a heterocyclyl group having 5 or 6 ring members, which can be substituted by one of the following groups: halogen, nitro, cyano, trifluoromethyl, trifluoromethoxy, C₁₋₃ alkyl and C₁₋₃alkoxy;
or a pharmaceutically acceptable salt or a stereoisomeric form thereof, and comprising at least one pharmaceutically acceptable oily component (C), and comprising water and optionally comprising one or several further components (F).

The groups R¹⁰ and R¹¹ often denote hydrogen atoms.

The composition often contains 0.01 to 0.5% by weight of the pyrazolo[1,5-a]pyrimidine compound (P) of formula (I), from about 5 to about 30% by weight of at least one pharmaceutically acceptable oily component (C), from about 70 to about 95% by weight of water and optionally comprising 0.1 to 5% by weight of one or several further components (F).

The liquid (or semi solid) pharmaceutical composition according to the invention often consists of the pyrazolo[1,5-a]pyrimidine compound of formula (I), water as the main component (more than 70% by weight), at least one oily component (C) and one or several further components (F).

The liquid (or semi solid) pharmaceutical composition according to the invention often is consisting of the pyrazolo[1,5-a]pyrimidine compound of formula (I), water at the main component (70% to 90% by weight), at least two different oily components (C) and one or several further components (F).

The liquid (or semi solid) pharmaceutical composition often is comprising at least one pyrazolo[1,5-a]-pyrimidine compound of formula (I) in which the radicals denote: R¹⁰ and R¹¹ independently represent hydrogen, halogen, amino, hydroxy, nitro, cyano, trifluoromethyl, trifluoromethoxy, C₁-C₃alkyl, C₁-C₃alkyloxy, cyclohexyl, phenyl, or a ring system from the group: thiophene, pyrrole, furane, pyrazole, tetrazole, oxazole, isoxazole, thiazole, pyridine, pyrimidine and morpholino, or a pharmaceutically acceptable salt or a stereoisomeric form thereof. Often R¹⁰ and R¹¹ in formula (I) both represent hydrogen.

The liquid (or semi solid) pharmaceutical composition often is comprising at least one pyrazolo[1,5-a]pyrimidine compound of formula (I) in which R², R³, R⁴ and R⁵ independently represent hydrogen, methyl, ethyl or trifluoromethyl; and R⁶ and R⁷ independently represent hydrogen or methyl, or a pharmaceutically acceptable salt or a stereoisomeric form thereof.

The liquid (or semi solid) pharmaceutical composition often is comprising at least one pyrazolo[1,5-a]pyrimidine compound of formula (I) in which one of R² and R³ represents methyl, ethyl or trifluoromethyl and the remaining of R² and R³ represents hydrogen, or a pharmaceutically acceptable salt or a stereoisomeric form thereof.

The liquid (or semi solid) pharmaceutical composition often is comprising a pyrazolo[1,5-a]pyrimidine compound of formula (I) in which R¹ denotes bromo, and one of R² and R³ represents methyl, ethyl or trifluoromethyl and the remaining of R² and R³ represents hydrogen, or a pharmaceutically acceptable salt or a stereoisomeric form thereof.

The liquid (or semi solid) pharmaceutical composition often is comprising at least one pyrazolo[1,5-a]pyrimidine compound of formula (I), wherein R¹ denotes bromo, and R² represents methyl or ethyl and R³, R⁴, R⁵, R⁶, R⁷, R¹⁰ and R¹¹ all represent hydrogen and which has at least one chiral carbon atom in the R-configuration, or a pharmaceutically acceptable salt thereof.

The liquid (or semi solid) pharmaceutical composition often is comprising from 0.01 to 0.5% be weight of a pyrazolo[1,5-a]pyrimidine compound of formula (I), wherein at least three groups Y¹ to Y⁴ denote a carbon atom, R¹ denotes bromo, R² denotes methyl, R³, R⁴, R⁵, R⁶, R⁷, R¹⁰ and R¹¹ all represent hydrogen.

The liquid (or semi solid) pharmaceutical composition often is comprising at least one pyrazolo[1,5-a]pyrimidine compound of formula (I), which has an octanol/water partition coefficient of log P value from 2 to 5, often from 3 to 4.

The liquid (or semi solid) pharmaceutical composition often comprises from 0.01 to 0.5% by weight of the compound of formula (A)

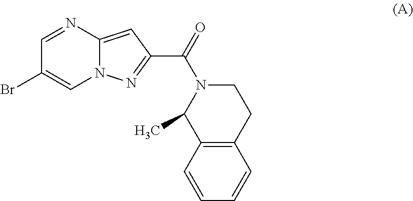 [SMILES: C[C@@H]1c2ccccc2CCN1C(=O)c1cc2ncc(Br)cn2n1]

or a pharmaceutically acceptable salt thereof.

The liquid (or semi solid) pharmaceutical composition often comprises:
15 to 25% by weight of a pharmaceutically acceptable oily component (C), which oily component (C) comprises at least 80% by weight of at least two different types of triglycerides,
and comprising at least 75% by weight of water and
optionally comprising 0.1 to 6% by weight one or several further components (F).

The oily component (C) often comprises:
(C1) from 40 to 60% by weight of triglycerides of formula (II)

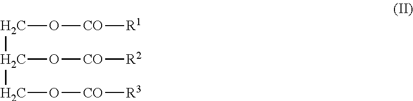

wherein at least 98% by weight of R¹, R² and R³ are saturated or unsaturated fatty acid with 14-24 carbon atoms, and
(C2) from 40 to 60% by weight of triglycerides of formula (III),

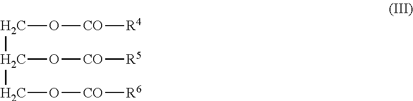

wherein at least 97% by weight of R⁴, R⁵ and R⁶ are saturated or unsaturated fatty acid with 8-12 carbon atoms.

The liquid (or semi solid) pharmaceutical composition often comprises:

15 to 25% by weight of a pharmaceutically acceptable oily component (C), which as component (C1) contains the following amounts of fatty acids (in weight percent of the total amount of fatty acids in the oily component C1):

| | |
|---|---|
| 48-60 | linoleic acid |
| 08-14 | palmitic acid |
| 16-30 | oleic acid |
| 05-12 | linoleic acid |
| 02-06 | stearic acid |
| up to 21 | other C14-C24 fatty acids. |

The liquid (or semi solid) pharmaceutical composition often comprises an oily component, where:

the oily component (C) comprises as component C1 at least 45% by weight (of component C) soybean oil and as component C2 at least 45% by weight (of component C) triglycerides of formula (III) wherein:

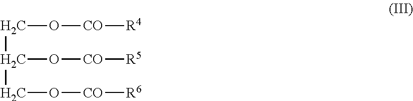

wherein the oily component (III) contains the following amounts of fatty acids (in weight percent of the total amount of fatty acids in the oily component C2):

| | |
|---|---|
| 50-80 | caprylic acid |
| 20-50 | capric acid |
| 01-03 | lauric acid |
| up to 29 | other C6-C14 fatty acids. |

In one embodiment of the invention, as component (II), (refined) soybean oil is used. In one embodiment, as oily component of formula (III), middle chain triglycerides are used.

The liquid pharmaceutical composition often comprises:
0.01 to 0.5% by weight of compound of formula (A),
70 to 80% by weight of water,
0 to 6% by weight of one or several further components (F),
15 to 20% by weight of the oily component (C),
which oily component (C) comprises:
C1: 40 to 60% by weight of soybean oil and
C2: 60 to 40% by weight of triglycerides of formula (III).

The liquid (or semi solid) pharmaceutical composition often comprises from 2 to 6% by weight of one or several further components (F), in particular an emulsifier and a component for regulating the tonicity (such as glycerol or sodium chloride).

The liquid (or semi solid) pharmaceutical composition often is an aqueous emulsion composition comprising an amount of the pyrazolo[1,5-a]pyrimidine compound (P) is in the range from 0.1 to 5 mg/ml.

The liquid pharmaceutical composition often is an aqueous emulsion composition, comprising at least 75% by weight of water and comprising at least 10% by weight of the oily component (C) and comprising a concentration of the pyrazolo[1,5-a]pyrimidine compound (P) in the range from 0.1 to 5 mg/ml, and which further may comprise as further component (F) a tonicity adjusting agent (such as glycerol or sodium chloride), a pH-regulator and/or a phosphatidyl-choline component as emulsifier.

The liquid (or semi solid) pharmaceutical composition often is an aqueous emulsion composition which comprises as further component (F) a pH-regulator (e.g. sodium hydroxide) or a buffering system. The stability of the aqueous emulsion composition can be improved by choosing a pH value higher than 7, often in the range of 7.1 to 8.5, in particular from 7.1 to 8.0.

The liquid (or semi solid) pharmaceutical compositions can be used for the treatment of a disorder or a disease of the central nervous system.

The invention also relates to a process for the preparation of a liquid (or semi solid) pharmaceutical composition as described above, comprising the steps of mixing together at least one pyrazolo[1,5-a]pyrimidine compound (P) or a pharmaceutically acceptable salt or a stereo-isomeric form thereof, and at least one pharmaceutically acceptable oily component (C) and optionally one or several further components (F), where the mixing of the components is made by applying high shear and/or high pressure homogenization steps.

The liquid pharmaceutical compositions as described above normally contain water as main component and, together with the active compound (P), an oily component (C). Various oily components (C) are known in the literature for nutritional and medical purposes. Typical examples of oily components are vegetable or synthetic fats and oils.

Specific examples include, for example, as vegetable fats and oils, soybean oil (e.g. Soiae oleum raffinatum), olive oil (e.g. Olivae oleum raffinatum), castor oil (e.g. Ricini oleum raffinatum), thistle oil (e.g. Carthami oleum raffinatum), safflower oil, cotton oil (e.g. Gossypii oleum hydrogenatum), wheat germ oil (e.g. Tritici aestivi oleum raffinatum), avocado oil, evening primrose oil and sesame oil. The use of refined soybean oil is preferred.

As animal fats and oils, for example, DHA, EPA, liver oil, yolk oil, seal oil, porcine oil and bovine oil have be used for various purposes.

Some examples of synthetic oils and fats include medium chain fatty acid triglycerides, such as the commercial product Miglyol 812.

For the purpose of this invention, also mixtures of two or more types of oily components (C) may also be used.

It is advantageous to choose one or preferably two appropriate oily components (C) depending on the type of substituted pyrazolo[1,5-a]pyrimidine active ingredient, in order to improve the solubility of the active ingredient.

When liquid compositions are prepared, e. g. in form of solutions or emulsions, by solving the substituted pyrazolo[1,5-a]pyrimidine in one or more oily components (C), one or two or more additional components (F) can be used.

These additional components (F) are in particular pharmaceutical excipients selected from the group of pH-regulators (such as NaOH) and buffering agents, emulsifiers (such as phosphatidyl cholines and derivatives), additional emulsifiers (such as sodium-oleat), suspending agents, stabilizers, antioxidants, colorants, wetting agents, aggregation inhibitors, co-solvents and compounds for regulating the isotonic character of the composition (such as glycerol).

Examples of the alternative dissolving agents include glycerin fatty acid esters, sucrose fatty acid esters, white beeswax and hardened oil.

When the aforementioned pharmaceutical excipients are used, each may generally be added in an amount within the range of about 0.1 to 5% by weight, preferably 0.2 to 4% by weight (of the total composition). The amount of glycerol in the composition often is in the range of 2 to 3% by weight. The amount of emulsifier (e.g. phosphatidyl choline) in the composition often is in the range of 1 to 4% by weight. The amount of additional emulsifier (e.g. oleic acid salts) in the composition often is in the range of 0.1 to 1.5% by weight.

Wetting agents or surfactants or tensides or emulsifying agents are chemical substances that increase the spreading and penetrating properties of a liquid by lowering its surface tension, which means the tendency of its molecules to adhere to each other. The extent of wetting of a compound by water is dependent on the hydrophilicity of the compound. The more hydrophobic the compound, the more difficult to get it wet by water. Inability of wetting reflects the higher interfacial tension between the compound and the liquid.

The interfacial tension can be reduced so that air is displaced from the solid surface of the compound by the liquid. Often, non-ionic and anionic surfactants are used as wetting agents in pharmaceutical practice, such as non-ionic surfactants having a HLB value from 7 to 10. Typical examples are polysorbates, Docusate sodium, Poloxamer and Sodium lauryl sulfate.

Typical emulsifiers are phosphatidyl cholines, lecithines and others. Typical lecithines and phosphatidyl cholines to be used in the compositions according to the invention are lecithins or lecithin based derivatives such as Lipoid 75S and Lipoid 90G, (commercially available, e.g. via Lipoid GmbH, Germany, Ludwigshafen) and Phospholipom 90G (commercially available, e.g. via Phospholipid GmbH, Germany, Köln).

Although an amount of the pyrazolopyrimidine contained in the pharmaceutical compositions of the present invention is not particularly limited, the amount may be from 0.01 to 2%, in particular 0.05 to 1%, often from 0.1 to 0.5% by weight, based on the total weight of the liquid composition (e.g. emulsion).

Although an amount of the oily component (C) in the composition is not particularly limited, the amount may be from 10 to 30%, often from 15 to 25% by weight, based on the total mass of the pharmaceutical composition. Furthermore, it is possible to add one or two or more types of other further components (F).

By special manufacturing methods, the liquid pharmaceutical compositions containing at least one pyrazolopyrimidine derivative (P) can be prepared, which increase the solubility of a pyrazolopyrimidine derivative (P) into the milligram/ml range. The formation of stable liquid compositions of the pyrazolo[1,5-a]pyrimidine derivative (P) and an oily component (C) can occur by applying high shear and/or high pressure homogenization steps, either with or without heating. This can be achieved by preparing a pre-emulsion e.g. by using a homogenizer (Ultra-Turrax®) e.g. with 8000 U/min, and then applying a step of high-pressure homogenization, e.g. by using a Microfluidizer (e.g. M110S from Microfluidics)

The invention in particular relates to a pharmaceutical composition comprising at least one hydrophobic pyrazolo[1,5-a]pyrimidine compound of formula (I), which has an octanol/water partition coefficient (log P) greater than 1, in particular from 2 to 5 and often from 2.1 to 4.5.

The invention also relates to a pharmaceutical composition comprising a pyrazolo[1,5-a]-pyrimidine compound (P) with the following formula (A)

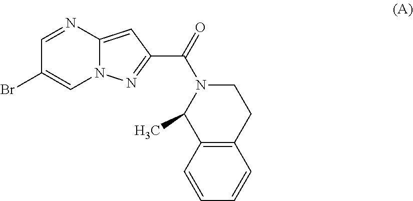 [SMILES: C[C@@H]1c2ccccc2CCN1C(=O)c1cc2ncc(Br)cn2n1]

and at least one pharmaceutically acceptable oily component (C), which preferably comprises a vegetable oil and a synthetic oil, and optionally a further active ingredient (B) and/or one or several further components (F).

The further active ingredients (B) and the further components (F) are described later more in detail.

The invention also relates to a pharmaceutical composition wherein the oily component or components (C) is selected from the group consisting of:
Soybean oil,
MCT (e.g. from Fagron or Caelo),
Castor oil and
mixtures (combinations) of two or three of these components.

In one embodiment of the invention, the oily component (C) is a mixture of soybean oil and synthetic triglyceride of formula (III).

The invention also relates to a liquid pharmaceutical composition wherein the ratio of water and the oily component (C) is in the range from 10:1 to 3:1; in particular from 6:1 to 3:1; often from 5:1 to 4:1.

The invention also relates to a pharmaceutical composition wherein the composition is a liquid composition, comprising an amount of the pyrazolo[1,5-a]pyrimidine compound (P) in the range from 0.1 to 20 mg/ml, preferably from 0.5 to 10 mg/ml, often from 1 to 5 mg/ml.

The invention also relates to a pharmaceutical composition wherein the composition is an aqueous liquid composition, comprising at least 70% by weight of water and comprising at least 10% by weight of an oily component.

The composition may comprise as further component (F) one or several excipients, in particular one or several emulsifiers and one or several compounds for regulating the isotonic character of the composition (such as glycerol). Typical emulsifiers are phosphatidyl cholines, lecithines and others. The emulsifier often is used in an amount of less than 5 percent by weight, in particular less than 4 percent by weight of the total liquid composition.

The invention also relates to a pharmaceutical composition for the treatment of a disorder or a disease of the central nervous system, in particular of those CNS-diseases described below (such as Alzheimer or Parkinson disease).

A further aspect of the invention deals with a process for preparation of a pharmaceutical composition as described above, comprising the steps of mixing together at least one pyrazolo[1,5-a]pyrimidine compound (P) or a pharmaceutically acceptable salt or a stereoisomeric form thereof, and at least one pharmaceutically acceptable oily component (C) and optionally one or several further components (F), where the process encompasses the step of preparing a solution of compound (P) in the oily component (C), then preparing a pre-emulsion which is further homogenized by applying high pressure homogenization steps.

One preferred process for preparation of a pharmaceutical composition as described above encompasses the steps of:
a) Heat the oily mixture to a temperature of 30 to 70° C., potentially add the emulsifier (such as Phospholipon 90 G or Lipoid S75) while mixing;
b) Dissolve the pyrazolopypimidine (P) in the oily component (C),

e. g. soybean oil, using heat and/or ultrasonification;
c) Potentially add co-solvent (such as Glycerol) to the aqueous phase, while continue to heat to a temperature from 30 to 70° C.;
d) Add aqueous phase to oily mixture stepwise using a medium to high energy device (such as the Ultra Turrax), preferably at 4000 to 9000 rpm for 0.5 to 10 minutes, e. g. at 9500 rpm or higher, to form a pre-emulsion;
e) Treat the pre-emulsion with a high pressure device (such as a French Press or a Microfluidiser, e.g. two cycles at 800 bar) to form a stable emulsion;
f) Fill up with additional water if final volume is not complete.

Additional filtration and/or cooling steps can be applied in this process.

The process can also encompass the step of introducing the oily phase into the aqueous phase (e.g. as described in the experimental part).

It was observed that different types of oily components (C) improve the solubility of pyrazolo[1,5-a]-pyrimidine derivatives with pronounced differences. In particular the use of specific triglycerides was found very effective for component (C).

Certain triglycerides of formulae (II) and (III) are well tolerated on many human application routes like the oral or parenteral routes, such as refined soybean oil. Certain triglycerides of formulae (II) and (III) are also toxicologically well characterized.

For the treatment of disorders and conditions of the central nervous system (CNS), various heterocyclic drug compounds have been developed in recent years, however many diseases, like Alzheimers or Parkinson cannot be treated adequately at low cost because of complex chemical structures, low solubilities, limited tolerability and minimal efficacy of the heterocyclic compounds.

The new liquid pharmaceutical compositions can easily be prepared, based on water, low-cost oily components (C) and small amounts of additional excipientes (F), which compositions are easily applicable to humans and animals, and are well tolerated and have an acceptable long-term stability. The compositions described above can be e. g. in the form of a semi-solid composition (e.g. gel or cream) or a liquid composition (e.g. solution or emulsion). Surprisingly, it was found that the solubility of pyrazolopyrimidine derivatives of formula (I) can be considerably be improved by the use of oily components (C). Stable liquid formulations of the pyrazolo[1,5-a]pyrimidine derivatives (P) can be provided, which can be stored for many months, even at elevated temperature.

One aspect of the invention relates to a pharmaceutical composition, wherein the composition is an aqueous liquid composition comprising at least 70% by weight of water and wherein the concentration of the compound of formula (I), in particular of formula (A), is in the range from 1 mg/ml to 50 mg/ml.

The invention also relates to a pharmaceutical composition comprising a hydrophobic pyrazolopyrimidine compound (P). The hydrophilicity and lipophilicity can be determined by the octanol/water partition coefficient (log P), for example according to the standard methods mentioned herein. Generally, a compound having an octanol/water partition coefficient of log P<1 will be considered hydrophilic. A compound having an octanol/water partition coefficient of log P>1 will be considered lipophilic.

The invention also relates to a pharmaceutical composition, such as an aqueous composition, comprising as further component (F) a co-solvent and/or a preservative and/or an emulsifier. The invention also relates in general to a composition comprising a phosphatidyl choline as emulsifier, e. g. in a concentration from 0.5 to 3% by weight, often from 1 to 2% by weight (of the total formulation).

The invention also relates to a pharmaceutical composition as described above for the treatment of a disorder or a disease of the central nervous system, such as the following diseases:
Alzheimer's disease, Creutzfeld-Jakob's syndrome/disease, bovine spongiform encephalopathy (BSE), diseases involving β-amyloid and/or tauopathy, motor neuron diseases, amyotrophic lateral sclerosis (ALS), olivoponto-cerebellar atrophy, post-operative cognitive deficit (POCD), systemic lupus erythematosus, systemic clerosis, Sjogren's syndrome, Neuronal Ceroid Lipofuscinosis, neurodegenerative cerebellar ataxias, Parkinson's disease, Parkinson's dementia, cognitive impairment, cognitive deficits in various forms of mild cognitive impairment, cognitive deficits in various forms of dementia, dementia pugilistica, vascular and frontal lobe dementia, cognitive impairment, learning impairment, eye injuries, eye diseases, eye disorders, glaucoma, retinopathy, macular degeneration, head or brain or spinal cord injuries, head or brain or spinal cord trauma, trauma, hypoglycaemia, hypoxia, perinatal hypoxia, ischaemia, convulsions, epileptic convulsions, epilepsy, temporal lobe epilepsy, myoclonic epilepsy, inner ear insult, tinnitus, dyskinesias, L-dopa-induced dykinesias, chorea, Huntington's chorea, athetosis, dystonia, stereotypy, ballism, tardive dyskinesias, tic disorder, torticollis spasmodicus, blepharospasm, focal and generalized dystonia, nystagmus, hereditary cerebellar ataxias, corticobasal degeneration, tremor, essential tremor, abuse, addiction, nicotine addiction, nicotine abuse, alcohol addiction, alcohol abuse, opiate addiction, opiate abuse, cocaine addiction, cocaine abuse, amphetamine addiction, amphetamine abuse, anxiety disorders, panic disorders, anxiety and panic disorders, social anxiety disorder (SAD), attention deficit hyperactivity disorder (ADHD), attention deficit syndrome (ADS), restless leg syndrome (RLS), hyperactivity in children, autism, dementia, dementia in Alzheimer's disease, dementia in Korsakoff syndrome, Korsakoff syndrome, vascular dementia, major depressive disorder, depression, bipolar manic-depressive disorder, irritable bowel syndrome (IBS), migraine, multiple sclerosis (MS), muscle spasms, pain, chronic pain, acute pain, inflammatory pain, schizophrenia, spasticity, Tourette's syndrome, sleep disorders, anxiety disorder, obsessive-compulsive disorder, panic disorder, posttraumatic stress disorder, social phobia, phobic disorders and schizophreniform disorder.

In particular, Parkinson's disease and dyskinesias, such as L-dopa-induced dykinesias, can be treated by the composition comprising a compound (P) and an oily component (C).

The invention also relates to a process for preparation of a liquid pharmaceutical composition comprising the steps of mixing together at least one pharmaceutically acceptable compound of formula (I) and at least one pharmaceutically acceptable oily component (C) and if necessary further pharmaceutically acceptable components (F).

The invention also relates to the use of a combination of two oily components (C1) and (C2), for the preparation of a pharmaceutical composition comprising a pyrazolopyrimidine compound (P) for the treatment of a disease, in particular a CNS-disease The invention further relates to such a use, wherein the composition is an aqueous liquid composition comprising as further component (F) a co-solvent, a pH-regulator and/or an emulsifier.

The compounds of the invention are usually named according to the IUPAC or CAS nomenclature system. The term “derivative” is used herein in the conventional pharmaceutical sense referring to a molecule that structurally resembles a reference molecule, but has been modified in a controlled manner to replace one or more specific substituent(s) of the molecule with an alternate substituent, thereby generating a molecule which is structurally similar to the reference molecule.

The composition according to the invention may comprise the compound of formula (I) and/or a “pharmaceutically acceptable salt” and/or a “derivative” and/or a “polymorphic form” and/or one or several “stereoisomeric forms” of a compound of formula (I).

The term “pharmaceutically acceptable” refers to ingredients of the compositions that are physiologically tolerable and do not typically produce untoward reactions when administered to a mammal (such as a human). Preferably, as used herein, the term “pharmaceutically acceptable” means approved by a European or US-regulatory agency or listed in a recognized pharmacopeia for use in mammals. The compounds of the present invention may be in the form of pharmaceutically acceptable salts. “Pharmaceutically acceptable salts” refers to those salts which possess the biological effectiveness and properties of the parent compound and which are not biologically or otherwise undesirable. The nature of the salt is not critical, provided that it is non-toxic and does not substantially interfere with the desired pharmacological activity.

The compounds of the invention having at least one chiral center may exist in and be isolated in optically active (such as R- or S-isomers) and racemic forms. The present invention encompasses any racemic, optically active, polymorphic, tautomeric or stereoisomeric form, or mixture thereof, of a compound of the invention, which possesses the useful properties described herein.

The pharmaceutically acceptable salts of the compound (I) can be prepared by known methods. These salts include e. g. acid addition salts, such as salts made with hydrochloric, methylsulfonic, hydrobromic, hydroiodic, perchloric, sulfuric, nitric, phosphoric, acetic, propionic, glycolic, lactic, pyruvic, malonic, succinic, fumaric, tartaric, citric, benzoic, carbonic, cinnamic, mandelic, methanesulfonic, ethane-sulfonic, hydroxyl-ethanesulfonic, benezenesulfonic, p-toluenesulfonic, cyclohexane-sulfamic, salicyclic, p-aminosalicylic, 2-phenoxybenzoic or 2-acetoxybenzoic acid. Pharmaceutically acceptable salts also include base addition salts, e.g. using rations such as Na, K, Mg, Ca, alkyl-ammonium or choline.

All of these salts may be prepared by conventional means. The nature of the salt is not particularly critical, provided that it is non-toxic and does not substantially interfere with the desired pharmacological activity.

The invention in particular relates to aqueous liquid compositions containing a compound (A). These are liquid preparations wherein the major liquid component is water. The compositions normally contain at least 70% by weight, often about 80% by weight (w/w of the total composition) of water, but these aqueous liquid compositions further comprise other liquid components, such as one or several oily components (C) and pharmaceutically acceptable further components (F).

The invention also relates to semi-solid compositions. This term means a composition with low viscosity whose major liquid component is water. The semi-solid composition may comprise further components (F), such as pharmaceutically acceptable organic co-solvents, viscosity regulation polymers, pH-regulators, preservatives and emulsifiers. Examples of such liquid components are ethanol, propylene glycol, and polyethylene glycol, and in particular glycerol. Such water-miscible organic solvents may be incorporated for example in order to solubilise an insufficiently water-soluble ingredient, such as a lipophilic substance. The term semi-solid composition includes in particular gels, but also creams and ointments. In comparison to a liquid composition these formulations have an increased viscosity, compared to aqueous solutions. The viscosity of semi-solid compositions can be controlled by using one or several polymeric components or a combination of polymers.

The term “stereoisomeric form” of compound (I) is used herein in the conventional chemical sense to refer to a molecule that has the same summarizing chemical formula but differs in the structure. Typical examples are enantiomers, diastereoisomers and racemates. The term “heteroaryl” means an aromatic heterocyclic system, in particular having 5 or 6 membered ring systems, which contain at least one atom which is not a carbon atom, such as e.g. N, S, O. Typical examples are pyridine, pyrimidine, thiophene, etc. The term “heterocyclyl” means a non-aromatic heterocyclic system, in particular having 5 or 6 membered ring systems, which contain at least one atom which is not a carbon atom, such as e.g. N, S, O. Typical examples are piperidine, pyrolidine, etc.

The amount of the compound of formula (I) in the liquid pharmaceutical composition may be decided taking into account the desired pharmaceutical use (e.g. oral or parenteral CNS-formulations), the type of the active ingredient of formula (I) and the concentrations of the other ingredients.

The concentration of the active ingredient of formula (I) may be e. g. at least 0.5 mg/ml. If the active ingredient is a compound of formula (I), in particular of formula (A), the concentration in the liquid formulation often is in the range from 0.01 to 100 mg/ml, for example 0.1 to 50 mg/ml, and often from 1 to 10 mg/ml.

After parenteral or topic administration of the liquid (or semi solid) pharmaceutical composition, the compound of formula (I) is rapidly absorbed from the composition and becomes bioavailable.

The composition of the invention may further comprise, besides the pyrazolopyrimidine derivative (P) at least one further active ingredient (B), such as a further drug compound useful for the treatment of CNS-diseases. Typical examples are drug compounds commercialized for the treatment of Alzheimers or Parkinson disease.

For the liquid compositions, the preservation of the active compound of formula (I) can be important. It is possible to formulate the composition without any additional preservative. In one embodiment, the composition of the invention is substantially free of preservatives. In this context, the term “substantially” means that preservatives are not detectable in the composition, or only in concentrations which are generally considered irrelevant with regard to any preservation effects. The liquid pharmaceutical composition may optionally comprise as further component (F) at least one preservative. Whether a composition is effectively preserved may be determined according to tests known in the art.

The pharmaceutical composition can also contain as further component (F) a preservative such as benzalkonium chloride, cetylpyridium chloride, cetrimide, cetyl trimethyl-ammonium bromide, benzethonium chloride, chlorhexidine gluconate, ethanol, isopro-panol, propylen glycol, butylparaben, ethylparaben, methylparaben, propylparaben, sorbic acid, benzoic acid, thiomersal, organomercury components, chlorobutanol and/or benzyl alcohol.

The pharmaceutical composition can as further component (F) also contain a pH-regulator, e. g. to improve the stability. Typical examples are selected from the group consisting of physiologically acceptable acids, bases, and acidic and alkaline salts.

The preparation of the composition comprising the pyrazolopyrimidine (P) according to the invention is technically easy, quick and cost-efficient. For the preparation of the compositions, the components are e. g. weighed and the compound of formula (I) is combined (mixed) with measured amounts of the oily component (C) and optionally further components (F), optionally followed by intensive stirring until dissolution occurs. The mixture may be agitated and/or heated for some time, e. g. from 2 minutes to 64 hours. The solution may be further processed by filtration or centrifugation to remove residual particles. The oily phase is then combined with water to form a stable pre-emulsion. Then an emulsion is prepared by further high pressure mixing. If a solid formulation is desired, the solution described may be dried, such as by spray drying or freeze drying.

As pyrazolo[1,5-a]pyrimidin compounds (P) the following compounds are mentioned with the following chemical names:
(6-Bromo-pyrazolo[1,5-a]pyrimidin-2-yl)-(6-hydroxy-7-methoxy-1-methyl-3,4-dihydro-1H-isoquinolin-2-yl)-methanone
(6-Chloro-pyrazolo[1,5-a]pyrimidin-2-yl)-(1-methyl-3,4-dihydro-1H-isoquinolin-2-yl)-methanone
(6-Chloro-pyrazolo[1,5-a]pyrimidin-2-yl)-(3-methyl-3,4-dihydro-1H-isoquinolin-2-yl)-methanone
(6-Bromo-pyrazolo[1,5-a]pyrimidin-2-yl)-(3-methyl-3,4-dihydro-1H-isoquinolin-2-yl)-methanone
(6-Bromo-pyrazolo[1,5-a]pyrimidin-2-yl)-(3,3-dimethyl-3,4-dihydro-1H-isoquinolin-2-yl)-methanone
(6-Chloro-pyrazolo[1,5-a]pyrimidin-2-yl)-(3,3-dimethyl-3,4-dihydro-1H-isoquinolin-2-yl)-methanone
(6-Chloro-pyrazolo[1,5-a]pyrimidin-2-yl)-(3,4-dihydro-1H-isoquinolin-2-yl)-methanone
(6-Chloro-pyrazolo[1,5-a]pyrimidin-2-yl)-(6,7-dimethoxy-1-methyl-3,4-dihydro-1H-isoquinolin-2-yl)-methanone
(6-Chloro-pyrazolo[1,5-a]pyrimidin-2-yl)-(6,7-dimethoxy-3,4-dihydro-1H-isoquinolin-2-yl)-methanone
(6-Bromo-pyrazolo[1,5-a]pyrimidin-2-yl)-(6,7-dimethoxy-3,4-dihydro-1H-isoquinolin-2-yl)-methanone
(6-Bromo-pyrazolo[1,5-a]pyrimidin-2-yl)-(6,7-dimethoxy-1-methyl-3,4-dihydro-1H-isoquinolin-2-yl)-methanone
(6-Chloro-pyrazolo[1,5-a]pyrimidin-2-yl)-(6-hydroxy-7-methoxy-3,4-dihydro-1H-isoquinolin-2-yl)-methanone
(6-Chloro-pyrazolo[1,5-a]pyrimidin-2-yl)-(6-hydroxy-7-methoxy-1-methyl-3,4-dihydro-1H-isoquinolin-2-yl)-methanone
(6-Bromo-pyrazolo[1,5-a]pyrimidin-2-yl)-(6,7-dimethoxy-3-methyl-3,4-dihydro-1H-isoquinolin-2-yl)-methanone
(6-Chloro-pyrazolo[1,5-a]pyrimidin-2-yl)-(6,7-dimethoxy-3-methyl-3,4-dihydro-1H-isoquinolin-2-yl)-methanone
(6-Bromo-pyrazolo[1,5-a]pyrimidin-2-yl)-(6,7-dimethoxy-3,3-dimethyl-3,4-dihydro-1H-isoquinolin-2-yl)-methanone
(6-Chloro-pyrazolo[1,5-a]pyrimidin-2-yl)-(6,7-dimethoxy-3,3-dimethyl-3,4-dihydro-1H-isoquinolin-2-yl)-methanone
(6-Bromo-pyrazolo[1,5-a]pyrimidin-2-yl)-(8-methyl-5,8-dihydro-6H-[1,7]naphthyridin-7-yl)-methanone
(6-Chloro-pyrazolo[1,5-a]pyrimidin-2-yl)-(8-methyl-5,8-dihydro-6H-[1,7]naphthyridin-7-yl)-methanone
(6-Bromo-pyrazolo[1,5-a]pyrimidin-2-yl)-(1-methyl-3,4-dihydro-1H-[2,7]naphthyridin-2-yl)-methanone
(6-Chloro-pyrazolo[1,5-a]pyrimidin-2-yl)-(1-methyl-3,4-dihydro-1H-[2,7]naphthyridin-2-yl)-methanone
(6-Bromo-pyrazolo[1,5-a]pyrimidin-2-yl)-(1-methyl-3,4-dihydro-1H-[2,6]naphthyridin-2-yl)-methanone
(6-Chloro-pyrazolo[1,5-a]pyrimidin-2-yl)-(1-methyl-3,4-dihydro-1H-[2,6]naphthyridin-2-yl)-methanone
(6-Bromo-pyrazolo[1,5-a]pyrimidin-2-yl)-(5-methyl-7,8-dihydro-5H-[1,6]naphthyridin-6-yl)-methanone
(6-Chloro-pyrazolo[1,5-a]pyrimidin-2-yl)-(5-methyl-7,8-dihydro-5H-[1,6]naphthyridin-6-yl)-methanone
(6-Bromo-pyrazolo[1,5-a]pyrimidin-2-yl)-(1-methyl-3,4-dihydro-1H-isoquinolin-2-yl)-methanone
(6-Bromo-pyrazolo[1,5-a]pyrimidin-2-yl)-(3,4-dihydro-1H-isoquinolin-2-yl)-methanone
(6-Bromo-pyrazolo[1,5-a]pyrimidin-2-yl)-(7-fluoro-1-methyl-3,4-dihydro-1H-isoquinolin-2-yl)-methanone
(6-Bromo-pyrazolo[1,5-a]pyrimidin-2-yl)-(8-fluoro-1-methyl-3,4-dihydro-1H-isoquinolin-2-yl)-methanone
(6-Bromo-pyrazolo[1,5-a]pyrimidin-2-yl)-(6-fluoro-1-methyl-3,4-dihydro-1H-isoquinolin-2-yl)-methanone
(6-Bromo-pyrazolo[1,5-a]pyrimidin-2-yl)-(5-fluoro-1-methyl-3,4-dihydro-1H-isoquinolin-2-yl)-methanone
(6-Chloro-pyrazolo[1,5-a]pyrimidin-2-yl)-(7-fluoro-1-methyl-3,4-dihydro-1H-isoquinolin-2-yl)-methanone
(6-Chloro-pyrazolo[1,5-a]pyrimidin-2-yl)-(8-fluoro-1-methyl-3,4-dihydro-1H-isoquinolin-2-yl)-methanone
(6-Chloro-pyrazolo[1,5-a]pyrimidin-2-yl)-(6-fluoro-1-methyl-3,4-dihydro-1H-isoquinolin-2-yl)-methanone
(6-Chloro-pyrazolo[1,5-a]pyrimidin-2-yl)-(5-fluoro-1-methyl-3,4-dihydro-1H-isoquinolin-2-yl)-methanone
(6-Bromo-pyrazolo[1,5-a]pyrimidin-2-yl)-(8-fluoro-1-ethyl-3,4-dihydro-1H-isoquinolin-2-yl)-methanone
(6-Bromo-pyrazolo[1,5-a]pyrimidin-2-yl)-(7-fluoro-1-ethyl-3,4-dihydro-1H-isoquinolin-2-yl)-methanone
(6-Bromo-pyrazolo[1,5-a]pyrimidin-2-yl)-(6-fluoro-1-ethyl-3,4-dihydro-1H-isoquinolin-2-yl)-methanone
(6-Bromo-pyrazolo[1,5-a]pyrimidin-2-yl)-(5-fluoro-1-ethyl-3,4-dihydro-1H-isoquinolin-2-yl)-methanone
(6-Chloro-pyrazolo[1,5-a]pyrimidin-2-yl)-(8-fluoro-1-ethyl-3,4-dihydro-1H-isoquinolin-2-yl)-methanone
(6-Chloro-pyrazolo[1,5-a]pyrimidin-2-yl)-(7-fluoro-1-ethyl-3,4-dihydro-1H-isoquinolin-2-yl)-methanone
(6-Chloro-pyrazolo[1,5-a]pyrimidin-2-yl)-(6-fluoro-1-ethyl-3,4-dihydro-1H-isoquinolin-2-yl)-methanone
(6-Chloro-pyrazolo[1,5-a]pyrimidin-2-yl)-(5-fluoro-1-ethyl-3,4-dihydro-1H-isoquinolin-2-yl)-methanone
(6-Bromo-pyrazolo[1,5-a]pyrimidin-2-yl)-(8-fluoro-1-trifluoromethyl-3,4-dihydro-1H-isoquinolin-2-yl)-methanone
(6-Bromo-pyrazolo[1,5-a]pyrimidin-2-yl)-(7-fluoro-1-trifluoromethyl-3,4-dihydro-1H-isoquinolin-2-yl)-methanone
(6-Bromo-pyrazolo[1,5-a]pyrimidin-2-yl)-(6-fluoro-1-trifluoromethyl-3,4-dihydro-1H-isoquinolin-2-yl)-methanone
(6-Bromo-pyrazolo[1,5-a]pyrimidin-2-yl)-(5-fluoro-1-trifluoromethyl-3,4-dihydro-1H-isoquinolin-2-yl)-methanone
(6-Chloro-pyrazolo[1,5-a]pyrimidin-2-yl)-(8-fluoro-1-trifluoromethyl-3,4-dihydro-1H-isoquinolin-2-yl)-methanone
(6-Chloro-pyrazolo[1,5-a]pyrimidin-2-yl)-(7-fluoro-1-trifluoromethyl-3,4-dihydro-1H-isoquinolin-2-yl)-methanone
(6-Chloro-pyrazolo[1,5-a]pyrimidin-2-yl)-(6-fluoro-1-trifluoromethyl-3,4-dihydro-1H-isoquinolin-2-yl)-methanone
(6-Chloro-pyrazolo[1,5-a]pyrimidin-2-yl)-(5-fluoro-1-trifluoromethyl-3,4-dihydro-1H-isoquinolin-2-yl)-methanone
(6-Bromo-pyrazolo[1,5-a]pyrimidin-2yl)-(3-ethyl-1-methyl-3,4-dihydro-1H-isoquinolin-2-yl)methanone
(6-Bromo-pyrazolo[1,5-a]pyrimidin-2yl)-((R)-3-methyl-3,4-dihydro-1H-isoquinolin-2-yl)-methanone
(6-Bromo-pyrazolo[1,5-a]pyrimidin-2yl)-((S)-3-methyl-3,4-dihydro-1H-isoquinolin-2-yl)-methanone
(6-Chloro-pyrazolo[1,5-a]pyrimidin-2-yl)-(1-methyl-3,4-dihydro-1H-isoquinolin-2-yl)-methanone
(7-Bromo-3,4-dihydro-1H-isoquinolin-2-yl)-(6-chloro-pyrazolo[1,5-a]pyrimidin-2-yl)-methanone
(7-Bromo-3,4-dihydro-1H-isoquinolin-2-yl)-(6-bromo-pyrazolo[1,5-a]pyrimidin-2-yl)-methanone
(6-Chloro-pyrazolo[1,5-a]pyrimidin-2-yl)-(7-fluoro-1-methyl-3,4-dihydro-1H-isoquinolin-2-yl)-methanone
(6-Chloro-pyrazolo[1,5-a]pyrimidin-2-yl)-(1,4-dimethyl-3,4-dihydro-1H-isoquinolin-2-yl)-methanone
(6-Bromo-pyrazolo[1,5-a]pyrimidin-2-yl)-(1,4-dimethyl-3,4-dihydro-1H-isoquinolin-2-yl)-methanone
(6-Bromo-pyrazolo[1,5-a]pyrimidin-2-yl)-(1,4-dimethyl-3,4-dihydro-1H-isoquinolin-2-yl)-methanone
(6-Bromo-pyrazolo[1,5-a]pyrimidin-2-yl)-(1,4-dimethyl-3,4-dihydro-1H-isoquinolin-2-yl)-methanone
(6-Bromo-pyrazolo[1,5-a]pyrimidin-2-yl)-(1,4-dimethyl-3,4-dihydro-1H-isoquinolin-2-yl)-methanone
(6-Bromo-pyrazolo[1,5-a]pyrimidin-2-yl)-(1,4-dimethyl-3,4-dihydro-1H-isoquinolin-2-yl)-methanone
(6-Bromo-pyrazolo[1,5-a]pyrimidin-2-yl)-(6-methoxy-1-methyl-3,4-dihydro-1H-isoquinolin-2-yl)-methanone
(6-Chloro-pyrazolo[1,5-a]pyrimidin-2-yl)-(6-methoxy-1-methyl-3,4-dihydro-1H-isoquinolin-2-yl)-methanone
(6-Bromopyrazolo[1,5-a]pyrimidin-2yl)-(1-ethyl-3,4-dihydro-1H-isoquinolin-2-yl)methanone
(6-Bromopyrazolo[1,5-a]pyrimidin-2yl)-(1-isopropyl-3,4-dihydro-1H-isoquinolin-2-yl)methanone
(6-Chloro-pyrazolo[1,5-a]pyrimidin-2-yl)-(1-isopropyl-3,4-dihydro-1H-isoquinolin-2-yl)-methanone
(6-Chloro-pyrazolo[1,5-a]pyrimidin-2-yl)-(1-ethyl-3,4-dihydro-1H-isoquinolin-2-yl)-methanone
(6-Bromo-pyrazolo[1,5-a]pyrimidin-2-yl)-(1-trifluoromethyl-3,4-dihydro-1H-isoquinolin-2-yl)-methanone
(6-Choro-pyrazolo[1,5-a]pyrimidin-2-yl)-(1-trifluoromethyl-3,4-dihydro-1H-isoquinolin-2-yl)-methanone
(7-Bromo-1-methyl-3,4-dihydro-1H-isoquinolin-2-yl)-(6-bromo-pyrazolo[1,5-a]pyrimidin-2-yl)-methanone
(7-Bromo-1-methyl-3,4-dihydro-1H-isoquinolin-2-yl)-(6-chloro-pyrazolo[1,5-a]pyrimidin-2-yl)-methanone
(6-Bromo-pyrazolo[1,5-a]pyrimidin-2-yl)-(1-cyclohexyl-3,4-dihydro-1H-isoquinolin-2-yl)-methanone
(6-Chloro-pyrazolo[1,5-a]pyrimidin-2-yl)-(1-cyclohexyl-3,4-dihydro-1H-isoquinolin-2-yl)-methanone
(6-Bromo-pyrazolo[1,5-a]pyrimidin-2-yl)-(1-propyl-3,4-dihydro-1H-isoquinolin-2yl)-methanone
(6-Bromo-pyrazolo[1,5-a]pyrimidin-2-yl)-((S) 1-methyl-3,4-dihydro-1H-isoquinolin-2yl)-methanone;
(6-Bromo-pyrazolo[1,5-a]pyrimidin-2-yl)-((R) 1-methyl-3,4-dihydro-1H-isoquinolin-2yl)-methanone;
(5-Bromo-1-methyl-3,4-dihydro-1H-isoquinolin-2-yl)-(6-chloro-pyrazolo[1,5-a]pyrimidin-2yl)-methanone
(6-Bromo-pyrazolo[1,5-a]pyrimidin-2-yl)-5-methoxy-1-methyl-3,4-dihydro-1H-isoquinolin-2-yl)-methanone
(5-Bromo-1-methyl-3,4-dihydro-1H-isoquinolin-2-yl)-(6-bromo-pyrazolo[1,5-a]pyrimidin-2-yl)-methanone
(6-Bromo-pyrazolo[1,5-a]pyrimidin-2-yl)-(7-pyridin-4-yl-3,4-dihydro-1H-isoquinolin-2-yl)-methanone
(6-Bromo-pyrazolo[1,5-a]pyrimidin-2-yl)-(7-methoxy-1-methyl-3,4-dihydro-1H-isoquinolin-2-yl)-methanone
(6-Chloro-pyrazolo[1,5-a]pyrimidin-2-yl)-(7-methoxy-1-methyl-3,4-dihydro-1H-isoquinolin-2-yl)-methanone
(6-Bromo-1-methyl-3,4-dihydro-1H-isoquinolin-2yl)-(6-bromo-pyrazolo[1,5-a]pyrimidin-2-yl)-methanone
(6-Bromo-pyrazolo[1,5-a]pyrimidin-2-yl)-(5,6-dimethoxy-1-methyl-3,4-dihydro-1H-isoquinolin-2-yl)-methanone
(6-Bromo-pyrazolo[1,5-a]pyrimidin-2-yl)-(5,8-difluoro-1-methyl-3,4-dihydro-1H-isoquinolin-2-yl)-methanone
(6-Chloro-pyrazolo[1,5-a]pyrimidin-2-yl)-(5,8-difluoro-1-methyl-3,4-dihydro-1H-isoquinolin-2-yl)-methanone
(6-Bromo-pyrazolo[1,5-a]pyrimidin-2-yl)-(1-methyl-5-trifluoromethyl-3,4-dihydro-1H-isoquinolin-2-yl)-methanone
(6-Chloro-pyrazolo[1,5-a]pyrimidin-2-yl)-(1-methyl-5-trifluoromethyl-3,4-dihydro-1H-isoquinolin-2-yl)-methanone
(6-Chloro-pyrazolo[1,5-a]pyrimidin-2-yl)-(5-methyl-7,8-dihydro-5H-[1,6]naphthyridin-6-yl)-methanone
(3-Bromo-7,8-dihydro-5H-[1,6]naphthyridin-6-yl)-(6-chloro-pyrazolo[1,5-a]pyrimidin-2-yl)-methanone
(6-Bromo-pyrazolo[1,5-a]pyrimidin-2-yl)-(1-methyl-6-pyridin-3-yl-3,4-dihydro-1H-isoquinolin-2-yl)-methanone
(3-Bromo-7,8-dihydro-5H-[1,6]naphthyridin-6-yl)-(6-bromo-pyrazolo[1,5-a]pyrimidin-2-yl)-methanone
(6-Bromo-pyrazolo[1,5-a]pyrimidin-2-yl)-(1-methyl-7-pyridin-3-yl-3,4-dihydro-1H-isoquinolin-2-yl)-methanone
2-(6-Bromo-pyrazolo[1,5-a]pyrimidine-2-carbonyl-)1,2,3,4-tetrahydro-isoquinoline-7-carbonitrile
(6-Bromo-pyrazolo[1,5-a]pyrimidin-2-yl)-(1-methyl-7-pyridin-4-yl-3,4-dihydro-1H-isoquinolin-2-yl)-methanone
(6-Bromo-pyrazolo[1,5-a]pyrimidin-2-yl)-(5-nitro-3,4-dihydro-1H-isoquinolin-2-yl)-methanone
(6-Chloro-pyrazolo[1,5-a]pyrimidin-2-yl)-(5-nitro-3,4-dihydro-1H-isoquinolin-2-yl)-methanone
(6-Bromo-pyrazolo[1,5-a]pyrimidin-2-yl)-(1-methyl-7-pyrimidin-5-yl-3,4-dihydro-1H-isoquinolin-2-yl)-methanone
(6-Bromo-pyrazolo[1,5-a]pyrimidin-2-yl)-(7-morpholin-4-yl-3,4-dihydro-1H-isoquinolin-2-yl)-methanone
(6-Chloro-pyrazolo[1,5-a]pyrimidin-2-yl)-(7-morpholin-4-yl-3,4-dihydro-1H-isoquinolin-2-yl)-methanone
(6-Bromo-pyrazolo[1,5-a]pyrimidin-2-yl)-(8-morpholin-4-yl-3,4-dihydro-1H-isoquinolin-2-yl)-methanone
(6-Chloro-pyrazolo[1,5-a]pyrimidin-2-yl)-(8-morpholin-4-yl-3,4-dihydro-1H-isoquinolin-2-yl)-methanone
(6-Bromo-pyrazolo[1,5-a]pyrimidin-2-yl)-(6-morpholin-4-yl-3,4-dihydro-1H-isoquinolin-2-yl)-methanone
(6-Chloro-pyrazolo[1,5-a]pyrimidin-2-yl)-(6-morpholin-4-yl-3,4-dihydro-1H-isoquinolin-2-yl)-methanone
(6-Bromo-pyrazolo[1,5-a]pyrimidin-2-yl)-(5-morpholin-4-yl-3,4-dihydro-1H-isoquinolin-2-yl)-methanone
(6-Chloro-pyrazolo[1,5-a]pyrimidin-2-yl)-(5-morpholin-4-yl-3,4-dihydro-1H-isoquinolin-2-yl)-methanone
(6-Bromo-pyrazolo[1,5-a]pyrimidin-2-yl)-(1-methyl-6-pyrimidin-5-yl-3,4-dihydro-1H-isoquinolin-2-yl)-methanone
(6-Bromo-pyrazolo[1,5-a]pyrimidin-2-yl)-(1-methyl-5-pyrimidin-5-yl-3,4-dihydro-1H-isoquinolin-2-yl)-methanone
(6-Bromo-pyrazolo[1,5-a]pyrimidin-2-yl)-(1-methyl-5-pyrimidin-3-yl-3,4-dihydro-1H-isoquinolin-2-yl)-methanone
(3-Bromo-7,8-dihydro-5H-[1,6]naphthyridin-6-yl)-(6-bromo-pyrazolo[1,5-a]pyrimidin-2-yl)-methanone
(6-Chloro-pyrazolo[1,5-a]pyrimidin-2-yl)-(1-methyl-7-trifluoromethyl-3,4-dihydro-1H-isoquinolin-2-yl)-methanone
(6-Bromo-pyrazolo[1,5-a]pyrimidin-2-yl)-(1-methyl-7-trifluoromethyl-3,4-dihydro-1H-isoquinolin-2-yl)-methanone
(6-Chloro-pyrazolo[1,5-a]pyrimidin-2-yl)-(1,5-dimethyl-3,4-dihydro-1H-isoquinolin-2-yl)-methanone
(6-Chloro-pyrazolo[1,5-a]pyrimidin-2-yl)-(1,7-dimethyl-3,4-dihydro-1H-isoquinolin-2-yl)-methanone
(6-Bromo-pyrazolo[1,5-a]pyrimidin-2-yl)-(1,7-dimethyl-3,4-dihydro-1H-isoquinolin-2-yl)-methanone
(6-Bromo-pyrazolo[1,5-a]pyrimidin-2-yl)-(1,5-dimethyl-3,4-dihydro-1H-isoquinolin-2-yl)-methanone
(7-Chloro-1-methyl-3,4-dihydro-1H-isoquinolin-2-yl)-(6-chloro-pyrazolo[1,5-a]pyrimidin-2-yl)-methanone
(6-Bromo-pyrazolo[1,5-a]pyrimidin-2-yl)-(7-chloro-1-methyl-3,4-dihydro-1H-isoquinolin-2-yl)-methanone
(5-Chloro-1-methyl-3,4-dihydro-1H-isoquinolin-2-yl)-(6-chloro-pyrazolo[1,5-a]pyrimidin-2-yl)-methanone
N-[2-(6-Chloro-pyrazolo[1,5-a]pyrimidine-2-carbonyl)-1,2,3,4-tetrahydro-isoquinolin-5-yl]-acetamide
N-[2-(6-Bromo-pyrazolo[1,5-a]pyrimidine-2-carbonyl)-1,2,3,4-tetrahydro-isoquinolin-5-yl]-acetamide
N-[2-(6-Chloro-pyrazolo[1,5-a]pyrimidine-2-carbonyl)-1-methyl-1,2,3,4-tetrahydro-isoquinolin-5-yl]-acetamide
N-[2-(6-Bromo-pyrazolo[1,5-a]pyrimidine-2-carbonyl)-1-methyl-1,2,3,4-tetrahydro-isoquinolin-5-yl]-acetamide
N-[2-(6-Chloro-pyrazolo[1,5-a]pyrimidine-2-carbonyl)-1-methyl-1,2,3,4-tetrahydro-isoquinolin-5-yl]-acetamide
2-(6-Bromo-pyrazolo[1,5-a]pyrimidine-2-carbonyl)-1-methyl-1,2,3,4-tetrahydro-isoquinoline-5-carboxylic acid dimethylamide
2-(6-Chloro-pyrazolo[1,5-a]pyrimidine-2-carbonyl)-1-methyl-1,2,3,4-tetrahydro-isoquinoline-5-carboxylic acid dimethylamide
(6-Bromo-pyrazolo[1,5-a]pyrimidin-2-yl)-(8-methyl-2,3,5,8-tetrahydro-6H-1,4-dioxa-7-aza-phenanthren-7-yl)-methanone
2-(6-Bromo-pyrazolo[1,5-a]pyrimidine-2-carbonyl)-1,2,3,4-tetrahydro-isoquinoline-5-carbonitrile
2-(6-Bromo-pyrazolo[1,5-a]pyrimidine-2-carbonyl)-1,2,3,4-tetrahydro-isoquinoline-7-carbonitrile
(6-Bromo-pyrazolo[1,5-a]pyrimidin-2-yl)-(6-pyridin-4-yl-3,4-dihydro-1H-isoquinolin-2-yl)-methanone
(6-Chloro-pyrazolo[1,5-a]pyrimidin-2-yl)-(6-pyridin-4-yl-3,4-dihydro-1H-isoquinolin-2-yl)-methanone
(6-Chloro-pyrazolo[1,5-a]pyrimidin-2-yl)-(1-methyl-6-pyridin-4-yl-3,4-dihydro-1H-isoquinolin-2-yl)-methanone
(6-Bromo-pyrazolo[1,5-a]pyrimidin-2-yl)-(1-methyl-6-pyridin-4-yl-3,4-dihydro-1H-isoquinolin-2-yl)-methanone
(6-Bromo-pyrazolo[1,5-a]pyrimidin-2-yl)-(6-methyl-8,9-dihydro-6H-[1,3]dioxolo[4,5-f]isoquinolin-7-yl)-methanone
(6-Bromo-pyrazolo[1,5-a]pyrimidin-2-yl)-(1-methyl-5-pyridin-4-yl-3,4-dihydro-1H-isoquinolin-2-yl)-methanone
(6-Chloro-pyrazolo[1,5-a]pyrimidin-2-yl)-(1-methyl-5-pyridin-4-yl-3,4-dihydro-1H-isoquinolin-2-yl)-methanone
(6-Bromo-3,4-dihydro-1H-isoquinolin-2-yl)-(6-bromo-pyrazolo[1,5-a]pyrimidin-2-yl)-methanone
(6-Bromo-pyrazolo[1,5-a]pyrimidin-2-yl)-(6-pyridin-2-yl-3,4-dihydro-1H-isoquinolin-2-yl)-methanone
(6-Bromo-pyrazolo[1,5-a]pyrimidin-2-yl)-(1-methyl-6-pyridin-2-yl-3,4-dihydro-1H-isoquinolin-2-yl)-methanone
(6-Chloro-pyrazolo[1,5-a]pyrimidin-2-yl)-(1-methyl-6-pyridin-2-yl-3,4-dihydro-1H-isoquinolin-2-yl)-methanone
(6-Chloro-pyrazolo[1,5-a]pyrimidin-2-yl)-(1-methyl-7-pyridin-2-yl-3,4-dihydro-1H-isoquinolin-2-yl)-methanone
(5-Bromo-3,4-dihydro-1H-isoquinolin-2-yl)-(6-bromo-pyrazolo[1,5-a]pyrimidin-2-yl)-methanone
(5-Bromo-3,4-dihydro-1H-isoquinolin-2-yl)-(6-chloro-pyrazolo[1,5-a]pyrimidin-2-yl)-methanone
(6-Bromo-pyrazolo[1,5-a]pyrimidin-2-yl)-(5-pyridin-2-yl-3,4-dihydro-1H-isoquinolin-2-yl)-methanone
(6-Bromo-pyrazolo[1,5-a]pyrimidin-2-yl)-[5-(2,4-dimethoxy-pyrimidin-5-yl)-1-methyl-3,4-dihydro-1H-isoquinolin-2-yl]-methanone
(6-Chloro-pyrazolo[1,5-a]pyrimidin-2-yl)-[5-(2,4-dimethoxy-pyrimidin-5-yl)-1-methyl-3,4-dihydro-1H-isoquinolin-2-yl]-methanone
(6-Bromo-pyrazolo[1,5-a]pyrimidin-2-yl)-[5-(2,6-dimethoxy-pyridin-3-yl)-1-methyl-3,4-dihydro-1H-isoquinolin-2-yl]-methanone
(6-Chloro-pyrazolo[1,5-a]pyrimidin-2-yl)-[5-(2,6-dimethoxy-pyridin-3-yl)-1-methyl-3,4-dihydro-1H-isoquinolin-2-yl]-methanone
(6-Bromo-pyrazolo[1,5-a]pyrimidin-2-yl)-[5-(6-fluoro-pyridin-3-yl)-1-methyl-3,4-dihydro-1H-isoquinolin-2-yl]-methanone
(6-Chloro-pyrazolo[1,5-a]pyrimidin-2-yl)-[5-(6-fluoro-pyridin-3-yl)-1-methyl-3,4-dihydro-1H-isoquinolin-2-yl]-methanone
(6-Bromo-pyrazolo[1,5-a]pyrimidin-2-yl)-[5-(2-methoxy-pyridin-3-yl)-1-methyl-3,4-dihydro-1H-isoquinolin-2-yl]-methanone
(6-Chloro-pyrazolo[1,5-a]pyrimidin-2-yl)-[5-(2-methoxy-pyridin-3-yl)-1-methyl-3,4-dihydro-1H-isoquinolin-2-yl]-methanone
(6-Chloro-pyrazolo[1,5-a]pyrimidin-2-yl)-[5-(6-methoxy-pyridin-3-yl)-1-methyl-3,4-dihydro-1H-isoquinolin-2-yl]-methanone
(6-Bromo-pyrazolo[1,5-a]pyrimidin-2-yl)-[5-(6-methoxy-pyridin-3-yl)-1-methyl-3,4-dihydro-1H-isoquinolin-2-yl]-methanone
(6-Bromo-pyrazolo[1,5-a]pyrimidin-2-yl)-[6-(2-methoxy-pyridin-3-yl)-1-methyl-3,4-dihydro-1H-isoquinolin-2-yl]-methanone
(6-Chloro-pyrazolo[1,5-a]pyrimidin-2-yl)-[6-(2-methoxy-pyridin-3-yl)-1-methyl-3,4-dihydro-1H-isoquinolin-2-yl]-methanone
(6-Bromo-pyrazolo[1,5-a]pyrimidin-2-yl)-[6-(2-fluoro-pyridin-3-yl)-1-methyl-3,4-dihydro-1H-isoquinolin-2-yl]-methanone
(6-Chloro-pyrazolo[1,5-a]pyrimidin-2-yl)-[6-(2-fluoro-pyridin-3-yl)-1-methyl-3,4-dihydro-1H-isoquinolin-2-yl]-methanone
(6-Bromo-pyrazolo[1,5-a]pyrimidin-2-yl)-[6-(6-fluoro-pyridin-3-yl)-1-methyl-3,4-dihydro-1H-isoquinolin-2-yl]-methanone
(6-Chloro-pyrazolo[1,5-a]pyrimidin-2-yl)-[6-(6-fluoro-pyridin-3-yl)-1-methyl-3,4-dihydro-1H-isoquinolin-2-yl]-methanone
(6-Bromo-pyrazolo[1,5-a]pyrimidin-2-yl)-[6-(2,6-dimethoxy-pyridin-3-yl)-1-methyl-3,4-dihydro-1H-isoquinolin-2-yl]-methanone
(6-Chloro-pyrazolo[1,5-a]pyrimidin-2-yl)-[6-(2,6-dimethoxy-pyridin-3-yl)-1-methyl-3,4-dihydro-1H-isoquinolin-2-yl]-methanone
(6-Bromo-pyrazolo[1,5-a]pyrimidin-2-yl)-[6-(2,4-dimethoxy-pyrimidin-5-yl)-1-methyl-3,4-dihydro-1H-isoquinolin-2-yl]-methanone
(6-Chloro-pyrazolo[1,5-a]pyrimidin-2-yl)-[6-(2,4-dimethoxy-pyrimidin-5-yl)-1-methyl-3,4-dihydro-1H-isoquinolin-2-yl]-methanone
(6-Chloro-pyrazolo[1,5-a]pyrimidin-2-yl)-[7-(6-methoxy-pyridin-3-yl)-1-methyl-3,4-dihydro-1H-isoquinolin-2-yl]-methanone
(6-Chloro-pyrazolo[1,5-a]pyrimidin-2-yl)-[7-(2-methoxy-pyridin-3-yl)-1-methyl-3,4-dihydro-1H-isoquinolin-2-yl]-methanone
(6-Bromo-pyrazolo[1,5-a]pyrimidin-2-yl)-[7-(2,4-dimethoxy-pyrimidin-5-yl)-1-methyl-3,4-dihydro-1H-isoquinolin-2-yl]-methanone
(6-Chloro-pyrazolo[1,5-a]pyrimidin-2-yl)-[7-(2,4-dimethoxy-pyrimidin-5-yl)-1-methyl-3,4-dihydro-1H-isoquinolin-2-yl]-methanone
(6-Bromo-pyrazolo[1,5-a]pyrimidin-2-yl)-[7-(2-fluoro-pyridin-3-yl)-1-methyl-3,4-dihydro-1H-isoquinolin-2-yl]-methanone
(6-Chloro-pyrazolo[1,5-a]pyrimidin-2-yl)-[7-(2-fluoro-pyridin-3-yl)-1-methyl-3,4-dihydro-1H-isoquinolin-2-yl]-methanone
(6-Bromo-pyrazolo[1,5-a]pyrimidin-2-yl)-[5-(2-fluoro-pyridin-3-yl)-1-methyl-3,4-dihydro-1H-isoquinolin-2-yl]-methanone
(6-Chloro-pyrazolo[1,5-a]pyrimidin-2-yl)-[5-(2-fluoro-pyridin-3-yl)-1-methyl-3,4-dihydro-1H-isoquinolin-2-yl]-methanone
(6-Bromo-pyrazolo[1,5-a]pyrimidin-2-yl)-(8-furan-2-yl-1-methyl-3,4-dihydro-1H-isoquinolin-2-yl)-methanone
(6-Bromo-pyrazolo[1,5-a]pyrimidin-2-yl)-(7-furan-2-yl-1-methyl-3,4-dihydro-1H-isoquinolin-2-yl)-methanone
(6-Bromo-pyrazolo[1,5-a]pyrimidin-2-yl)-(6-furan-2-yl-1-methyl-3,4-dihydro-1H-isoquinolin-2-yl)-methanone
(6-Bromo-pyrazolo[1,5-a]pyrimidin-2-yl)-(5-furan-2-yl-1-methyl-3,4-dihydro-1H-isoquinolin-2-yl)-methanone
(6-Bromo-pyrazolo[1,5-a]pyrimidin-2-yl)-[1-methyl-8-(5-methyl-furan-2-yl)-3,4-dihydro-1H-isoquinolin-2-yl]-methanone
(6-Bromo-pyrazolo[1,5-a]pyrimidin-2-yl)-[1-methyl-7-(5-methyl-furan-2-yl)-3,4-dihydro-1H-isoquinolin-2-yl]-methanone
(6-Bromo-pyrazolo[1,5-a]pyrimidin-2-yl)-[1-methyl-6-(5-methyl-furan-2-yl)-3,4-dihydro-1H-isoquinolin-2-yl]-methanone
(6-Bromo-pyrazolo[1,5-a]pyrimidin-2-yl)-[1-methyl-5-(5-methyl-furan-2-yl)-3,4-dihydro-1H-isoquinolin-2-yl]-methanone
(6-Bromo-pyrazolo[1,5-a]pyrimidin-2-yl)-(8-furan-3-yl-1-methyl-3,4-dihydro-1H-isoquinolin-2-yl)-methanone
(6-Bromo-pyrazolo[1,5-a]pyrimidin-2-yl)-(7-furan-3-yl-1-methyl-3,4-dihydro-1H-isoquinolin-2-yl)-methanone
(6-Bromo-pyrazolo[1,5-a]pyrimidin-2-yl)-(6-furan-3-yl-1-methyl-3,4-dihydro-1H-isoquinolin-2-yl)-methanone
(6-Bromo-pyrazolo[1,5-a]pyrimidin-2-yl)-(5-furan-3-yl-1-methyl-3,4-dihydro-1H-isoquinolin-2-yl)-methanone
(6-Bromo-pyrazolo[1,5-a]pyrimidin-2-yl)-[8-(3,5-dimethyl-isoxazol-4-yl)-1-methyl-3,4-dihydro-1H-isoquinolin-2-yl]-methanone
(6-Bromo-pyrazolo[1,5-a]pyrimidin-2-yl)-[7-(3,5-dimethyl-isoxazol-4-yl)-1-methyl-3,4-dihydro-1H-isoquinolin-2-yl]-methanone
(6-Bromo-pyrazolo[1,5-a]pyrimidin-2-yl)-[6-(3,5-dimethyl-isoxazol-4-yl)-1-methyl-3,4-dihydro-1H-isoquinolin-2-yl]-methanone
(6-Bromo-pyrazolo[1,5-a]pyrimidin-2-yl)-[5-(3,5-dimethyl-isoxazol-4-yl)-1-methyl-3,4-dihydro-1H-isoquinolin-2-yl]-methanone
(6-Bromo-pyrazolo[1,5-a]pyrimidin-2-yl)-[1-methyl-8-(1H-pyrazol-4-yl)-3,4-dihydro-1H-isoquinolin-2-yl]-methanone
(6-Bromo-pyrazolo[1,5-a]pyrimidin-2-yl)-[1-methyl-7-(1H-pyrazol-4-yl)-3,4-dihydro-1H-isoquinolin-2-yl]-methanone
(6-Bromo-pyrazolo[1,5-a]pyrimidin-2-yl)-[1-methyl-6-(1H-pyrazol-4-yl)-3,4-dihydro-1H-isoquinolin-2-yl]-methanone
(6-Bromo-pyrazolo[1,5-a]pyrimidin-2-yl)-[1-methyl-5-(1H-pyrazol-4-yl)-3,4-dihydro-1H-isoquinolin-2-yl]-methanone
(6-Bromo-pyrazolo[1,5-a]pyrimidin-2-yl)-[1-methyl-8-(1-methyl-1H-pyrazol-4-yl)-3,4-dihydro-1H-isoquinolin-2-yl]-methanone
(6-Bromo-pyrazolo[1,5-a]pyrimidin-2-yl)-[1-methyl-7-(1-methyl-1H-pyrazol-4-yl)-3,4-dihydro-1H-isoquinolin-2-yl]-methanone
(6-Bromo-pyrazolo[1,5-a]pyrimidin-2-yl)-[1-methyl-6-(1-methyl-1H-pyrazol-4-yl)-3,4-dihydro-1H-isoquinolin-2-yl]-methanone
(6-Bromo-pyrazolo[1,5-a]pyrimidin-2-yl)-[1-methyl-5-(1-methyl-1H-pyrazol-4-yl)-3,4-dihydro-1H-isoquinolin-2-yl]-methanone
(6-Bromo-pyrazolo[1,5-a]pyrimidin-2-yl)-[1-methyl-8-(3-methyl-1H-pyrazol-4-yl)-3,4-dihydro-1H-isoquinolin-2-yl]-methanone
(6-Bromo-pyrazolo[1,5-a]pyrimidin-2-yl)-[1-methyl-7-(3-methyl-1H-pyrazol-4-yl)-3,4-dihydro-1H-isoquinolin-2-yl]-methanone
(6-Bromo-pyrazolo[1,5-a]pyrimidin-2-yl)-[1-methyl-6-(3-methyl-1H-pyrazol-4-yl)-3,4-dihydro-1H-isoquinolin-2-yl]-methanone
(6-Bromo-pyrazolo[1,5-a]pyrimidin-2-yl)-[1-methyl-5-(3-methyl-1H-pyrazol-4-yl)-3,4-dihydro-1H-isoquinolin-2-yl]-methanone
(6-Bromo-pyrazolo[1,5-a]pyrimidin-2-yl)-[1-methyl-8-(2H-tetrazol-5-yl)-3,4-dihydro-1H-isoquinolin-2-yl]-methanone
(6-Bromo-pyrazolo[1,5-a]pyrimidin-2-yl)-[1-methyl-7-(2H-tetrazol-5-yl)-3,4-dihydro-1H-isoquinolin-2-yl]-methanone
(6-Bromo-pyrazolo[1,5-a]pyrimidin-2-yl)-[1-methyl-6-(2H-tetrazol-5-yl)-3,4-dihydro-1H-isoquinolin-2-yl]-methanone
(6-Bromo-pyrazolo[1,5-a]pyrimidin-2-yl)-[1-methyl-5-(2H-tetrazol-5-yl)-3,4-dihydro-1H-isoquinolin-2-yl]-methanone
6-Bromo-pyrazolo[1,5-a]pyrimidin-2-yl)-(1-methyl-3,4-dihydro-1H-[2,7]naphthyridin-2-yl)-methanone
(6-Bromo-pyrazolo[1,5-a]pyrimidin-2-yl)-(1-methyl-3,4-dihydro-1H-[2,6]naphthyridin-2-yl)-methanone
(6-Bromo-pyrazolo[1,5-a]pyrimidin-2-yl)-(5-methyl-7,8-dihydro-5H-pyrido[4,3-d]pyrimidin-6-yl)-methanone
(6-Bromo-pyrazolo[1,5-a]pyrimidin-2-yl)-(8-methyl-5,8-dihydro-6H-pyrido[3,4-d]pyrimidin-7-yl)-methanone
(6-Bromo-pyrazolo[1,5-a]pyrimidin-2-yl)-(1-methyl-5-nitro-3,4-dihydro-1H-isoquinolin-2-yl)-methanone
(6-Bromo-pyrazolo[1,5-a]pyrimidin-2-yl)-(1-methyl-6-nitro-3,4-dihydro-1H-isoquinolin-2-yl)-methanone
(6-Bromo-pyrazolo[1,5-a]pyrimidin-2-yl)-(1-methyl-7-nitro-3,4-dihydro-1H-isoquinolin-2-yl)-methanone
(6-Bromo-pyrazolo[1,5-a]pyrimidin-2-yl)-(1-methyl-8-nitro-3,4-dihydro-1H-isoquinolin-2-yl)-methanone
(6-Bromo-pyrazolo[1,5-a]pyrimidin-2-yl)-(1-methyl-5-nitro-3,4-dihydro-1H-[2,7]naphthyridin-2-yl)-methanone
2-(6-Bromo-pyrazolo[1,5-a]pyrimidine-2-carbonyl)-1-methyl-1,2,3,4-tetrahydro-isoquino line-5-carbonitrile
2-(6-Bromo-pyrazolo[1,5-a]pyrimidine-2-carbonyl)-1-methyl-1,2,3,4-tetrahydro-isoquinoline-5-carboxylic acid methyl ester
(6-Bromo-pyrazolo[1,5-a]pyrimidin-2-yl)-(2,6-dimethyl-8,9-dihydro-6H-3-oxa-1,7-diaza-cyclopenta[a]naphthalen-7-yl)-methanone
(6-Bromo-pyrazolo[1,5-a]pyrimidin-2-yl)-(4-methyl-1,4-dihydro-2H-[3,7]phenanthrolin-3-yl)-methanone
(6-Bromo-pyrazolo[1,5-a]pyrimidin-2-yl)-(2,6-dimethyl-8,9-dihydro-6H-thiazoto[4,5-f]isoquinolin-7-yl)-methanone
(6-Bromo-pyrazolo[1,5-a]pyrimidin-2-yl)-(5-methanesulfonyl-1-methyl-3,4-dihydro-1H-isoquinolin-2-yl)-methanone
(6-Bromo-pyrazolo[1,5-a]pyrimidin-2-yl)-(6-methanesulfonyl-1-methyl-3,4-dihydro-1H-isoquinolin-2-yl)-methanone
(6-Bromo-pyrazolo[1,5-a]pyrimidin-2-yl)-(7-methanesulfonyl-1-methyl-3,4-dihydro-1H-isoquinolin-2-yl)-methanone
(6-Bromo-pyrazolo[1,5-a]pyrimidin-2-yl)-(8-methanesulfonyl-1-methyl-3,4-dihydro-1H-isoquinolin-2-yl)-methanone
(6-Bromo-pyrazolo[1,5-a]pyrimidin-2-yl)-(4,7-dimethyl-1,4,7,8,9,10-hexahydro-2H-[3,7]phenanthrolin-3-yl)-methanone
1-[2-(6-Bromo-pyrazolo[1,5-a]pyrimidine-2-carbonyl)-1-methyl-1,2,3,4-tetrahydro-isoquinolin-5-yl]-ethanone
2-(6-Bromo-pyrazolo[1,5-a]pyrimidine-2-carbonyl)-1-methyl-1,2,3,4-tetrahydro-isoquinoline-6-carboxylic acid methyl ester
2-(6-Bromo-pyrazolo[1,5-a]pyrimidine-2-carbonyl)-1-methyl-1,2,3,4-tetrahydro-isoquinoline-7-carboxylic acid methyl ester
(6-Bromo-pyrazolo[1,5-a]pyrimidin-2-yl)-[1-methyl-5-(morpholine-4-carbonyl)-3,4-dihydro-1H-isoquinolin-2-yl]-methanone
(6-Bromo-pyrazolo[1,5-a]pyrimidin-2-yl)-[1-methyl-7-(morpholine-4-carbonyl)-3,4-dihydro-1H-isoquinolin-2-yl]-methanone
(6-Bromo-pyrazolo[1,5-a]pyrimidin-2-yl)-[1-methyl-6-(morpholine-4-carbonyl)-3,4-dihydro-1H-isoquinolin-2-yl]-methanone
(6-Bromo-pyrazolo[1,5-a]pyrimidin-2-yl)-(6-methyl-8,9-dihydro-6H-furo[3,2-f]isoquinolin-7-yl)-methanone
(6-Bromo-pyrazolo[1,5-a]pyrimidin-2-yl)-(3,6-dimethyl-3,6,8,9-tetrahydro-pyrrolo[3,2-f]isoquinolin-7-yl)-methanone
(6-Bromo-pyrazolo[1,5-a]pyrimidin-2-yl)-(8-methyl-5,8-dihydro-6H-furo[3,2-g]isoquinolin-7-yl)-methanone
7-(6-Bromo-pyrazolo[1,5-a]pyrimidine-2-carbonyl)-2,6-dimethyl-1,2,6,7,8,9-hexahydro-pyrrolo[3,4-f]isoquinolin-3-one
7-(6-Bromo-pyrazolo[1,5-a]pyrimidine-2-carbonyl)-2,6-dimethyl-2,3,6,7,8,9-hexahydro-pyrrolo[3,4-f]isoquinolin-1-one
(6-Bromo-pyrazolo[1,5-a]pyrimidin-2-yl)-(6-diethylamino-1-methyl-3,4-dihydro-1H-isoquinolin-2-yl)-methanone
(6-Bromo-pyrazolo[1,5-a]pyrimidin-2-yl)-(5-diethylamino-1-methyl-3,4-dihydro-1H-isoquinolin-2-yl)-methanone
(6-Bromo-pyrazolo[1,5-a]pyrimidin-2-yl)-(8-diethylamino-1-methyl-3,4-dihydro-1H-isoquinolin-2-yl)-methanone
(6-Bromo-pyrazolo[1,5-a]pyrimidin-2-yl)-(7-diethylamino-1-methyl-3,4-dihydro-1H-isoquinolin-2-yl)-methanone
(6-Bromo-pyrazolo[1,5-a]pyrimidin-2-yl)-(6,7-difluoro-1-methyl-3,4-dihydro-1H-isoquinolin-2-yl)-methanone
(6-Chloro-pyrazolo[1,5-a]pyrimidin-2-yl)-(6,7-difluoro-1-methyl-3,4-dihydro-1H-isoquinolin-2-yl)-methanone
(6-Bromo-pyrazolo[1,5-a]pyrimidin-2-yl)-(6,7-dichloro-1-methyl-3,4-dihydro-1H-isoquinolin-2-yl)-methanone
(6-Chloro-pyrazolo[1,5-a]pyrimidin-2-yl)-(6,7-dichloro-1-methyl-3,4-dihydro-1H-isoquinolin-2-yl)-methanone
(6-Bromo-pyrazolo[1,5-a]pyrimidin-2-yl)-(6,7-dibromo-1-methyl-3,4-dihydro-1H-isoquinolin-2-yl)-methanone
(6-Chloro-pyrazolo[1,5-a]pyrimidin-2-yl)-(6,7-dibromo-1-methyl-3,4-dihydro-1H-isoquinolin-2-yl)-methanone
(6-Bromo-pyrazolo[1,5-a]pyrimidin-2-yl)-(1-methyl-7-morpholin-4-yl-3,4-dihydro-1H-isoquinolin-2-yl)-methanone
(6-Chloro-pyrazolo[1,5-a]pyrimidin-2-yl)-(1-methyl-7-morpholin-4-yl-3,4-dihydro-1H-isoquinolin-2-yl)-methanone
(6-Bromo-pyrazolo[1,5-a]pyrimidin-2-yl)-(1-methyl-8-morpholin-4-yl-3,4-dihydro-1H-isoquinolin-2-yl)-methanone
(6-Chloro-pyrazolo[1,5-a]pyrimidin-2-yl)-(1-methyl-8-morpholin-4-yl-3,4-dihydro-1H-isoquinolin-2-yl)-methanone
(6-Bromo-pyrazolo[1,5-a]pyrimidin-2-yl)-(1-methyl-6-morpholin-4-yl-3,4-dihydro-1H-isoquinolin-2-yl)-methanone
(6-Chloro-pyrazolo[1,5-a]pyrimidin-2-yl)-(1-methyl-6-morpholin-4-yl-3,4-dihydro-1H-isoquinolin-2-yl)-methanone
(6-Bromo-pyrazolo[1,5-a]pyrimidin-2-yl)-(1-methyl-5-morpholin-4-yl-3,4-dihydro-1H-isoquinolin-2-yl)-methanone
(6-Chloro-pyrazolo[1,5-a]pyrimidin-2-yl)-(1-methyl-5-morpholin-4-yl-3,4-dihydro-1H-isoquinolin-2-yl)-methanone
(6-Bromo-pyrazolo[1,5-a]pyrimidin-2-yl)-(1-methyl-7-piperidin-1-yl-3,4-dihydro-1H-isoquinolin-2-yl)-methanone
(6-Chloro-pyrazolo[1,5-a]pyrimidin-2-yl)-(1-methyl-7-piperidin-1-yl-3,4-dihydro-1H-isoquinolin-2-yl)-methanone
(6-Bromo-pyrazolo[1,5-a]pyrimidin-2-yl)-(1-methyl-7-pyrrolidin-1-yl-3,4-dihydro-1H-isoquinolin-2-yl)-methanone
(6-Chloro-pyrazolo[1,5-a]pyrimidin-2-yl)-(1-methyl-7-pyrrolidin-1-yl-3,4-dihydro-1H-isoquinolin-2-yl)-methanone.

The invention is further illustrated by the following experiments and patent claims.

### Example 1

### Parenteral Formulation of Pyrazolopyrimidines

Different pharmaceutical compositions were prepared by using as pyrazolopyrimidine-component the compound (A), which has the chemical name:

(6-Bromo-pyrazolo[1,5-a]pyrimidine-2-yl)-(1(R)-methyl-3,4-dihydro-1H-isoquinoline-2-yl)-methanone, and which is of particular interest and has the formula (A) as described above. This compound (A) is the R-enantiomer, but both isomers (R and S) were prepared by classical chemical synthesis. The compound (A) was tested in various compositions (formulations) inter alia for CNS-applications. The compound (A) is a small molecule having a molecular weight of about 360 g/Mol, but is very little soluble in aqueous media at room temperature (about 0.001 to 0.01 mg/ml).

Compound (A) can be formulated together with various oily components (C) as aqueous based, liquid compositions with higher concentration of the drug substance. These formulations can be easily applied to different animal species and human beings via application routes like the parenteral route. The compound (A) is a lipophilic compound with limited wettability and solubility in aqueous media. The lipophilicity can be expressed by the log P value, which is approximately 3 for compound (A).

### Example 2

As pyrazolopyrimidine component, (6-Bromo-pyrazolo[1,5-a]-pyrimidine-2-yl)-(1(R)-methyl-3,4-dihydro-1H-isoquinoline-2-yl)-methanone was formulated with various oily components with higher concentrations of the drug substance using specific amounts of oily components (C). The following compositions were prepared by mixing the respective oily component (C) and the pyrazolopyrimidine compound, followed by filtration (PTFE-filter) and then analysis by High Performance Liquid Chromatography.

The following maximal solubilities of compound (A) were found (at 25° C.):
7 mg/ml in soybean oil
47 mg/ml in castor oil
6 mg/ml in olive oil
12 mg/ml in MCT.

The compound (A) was found to be sufficiently solubilised by the use of soybean oil, castor oil and MCT as component (C).

### Example 3

A liquid mixture was prepared by using 100 g of soybean oil and 100 g of MCT. The soybean oil is commercially available by Caelo (Caesar & Lorenz GmbH, Hilden, Germany). The component MCT is also commercially available (e.g. by Caelo). The solubility of compound (A) in this 50:50 (w/w) mixture of two oily components (C1) and (C2) was tested. Three different compositions were prepared (containing 1 mg/ml, 1.5 mg/ml and 2.0 mg/ml) of compound (A). In a further experiment, the maximum solubility of compound (A) in this mixture of oily components was found to be 8 mg/ml.

The oily phase containing the compound (A) was then mixed with an emulsifier (1%-3% by weight) of e.g. Lipoid S 75 Lipoid GmbH Germany, and afterwards with the aqueous phase containing a small amount (2.5% by weight) of a tonicity adjusting agent (Glycerol).

Different compositions were prepared containing about 10% to 20% of the oily component (C) and about 70 to 90% of water. These compositions were mixed by using an Ultra-Turrax-homogenizer followed by one to 10 cycles of high pressure homogenisation. These emulsions prepared are then characterized by microscopic analysis and by dynamic light-scattering methods (Horiba LB 500). Furthermore, laser diffraction experiments were made with the emulsions (EMan Coulter LS) and electro-acoustic experiments were performed (Dispersion Technology DT 300; Malvern Zetasizer Nano ZS).

For the emulsions prepared with compound (A), the average particle sizes of the oily components (comprising the active ingredient) were found to be less than 1.2 μm, preferably with D90-values from 0.2 to 1.2 μm. The emulsions were found to be stable over a period of more than 12 months.

By using the above-mentioned oily component (comprising soybean oil and MCT), it was possible to prepare stable emulsions of compound (A) containing up to 2 mg of compound (A) per ml of the emulsion. The stability of the emulsions prepared with compound (A) can be described by the Zeta-function which describes the degree of repulsion of particles having similar charges. The Zeta-potential of the emulsions were tested by acoustic and optical methods described in the literature.

Furthermore, the viscosities of the various emulsions tested were measured (using a rotation viscosimeter MCR 101). The emulsions tested had a viscosity (at room temperature) of about 2 to 3 mPas.

### Example 4

Emulsion with 0.5 mg/ml of Compound (A) for parenteral application in rats were prepared containing 10% soybean oil

### Composition:

| | Weight/ | |
|---|---|---|
| Substance | Volume | |
| Compound (A) | 50 | mg |
| Glycerol | 2.5 | g |
| Water, dest. | 25 | g |
| Phospholipon 90 G | 1.5 | g |
| Soybean oil | 10 | ml |
| Water, dest. | ad 100 | ml |
| Emulsion | 100 | ml |

### Method of Preparation for the Emulsion:

a) Dissolve the Compound (A) in the soybean oil using heat and/or ultrasonification.
b) Heat soybean oil solution to app. 40° C., add Phospholipon 90 G (emulsifier, purified phosphatidylcholine of Phospholipid GmbH, Germany, Köln) while mixing with the Ultra Turrax (T25 basic+10N) (at 8000 rpm).
c) Mix Glycerol and 12.5 g water, heat to a temperature of 40° C.
d) Add aqueous mixture to lipid mixture stepwise, still mixing with the Ultraturrax→5 minutes at 9500 rpm
e) Treat the emulsion with the French Press, 2 cycles at 800 bar (11600 psi or 740 at French Press scale)
f) Fill with water to 100 ml.

### Results:

Visual inspection: the emulsion looks homogeneous, no sign of precipitation of drug substance, no sign of phase separation.
Particle size distribution measured with Horiba: D90<299.7 nm
Emulsion pH: 5.6
Emulsion osmolality: 276 mmol/kg.

### Example 5

Emulsion with 5 mg/ml Compound (A) for oral application in rats were prepared containing 10% soybean oil and 10% MCT (middle chain triglycerides)

### Composition:

| | | Weight/ | |
|---|---|---|---|
| Substance | Composition | Volume | |
| Compound (A) | 5 mg/ml | 60 | mg |
| Glycerol | 2.5% | 300 | mg |
| Phospholipon 90 G | 2.25% | 270 | mg |
| Soybean oil | 10% | 1.2 | g |
| MCT | 10% | 1.2 | g |
| Water, dest. | | ad 12 | ml |
| Emulsion | 100% | 12 | ml |

### Preparation of the Emulsion:

a) The Compound (A) was dissolved in the mixture of soybean oil, MCT and Phospholipon 90 G. The mixture was mixed with the magnetic stirrer for app. 2 hours at temperature of 50° C. The Compound (A) could not be seen anymore, the yellowish solution was clear.
b) Glycerol was mixed with 9.5 g water and heated to app. 40° C. This mixture was added to the lipid blend stepwise and mixed with the Ultraturrax for 5 min. at 9500 rpm.
c) The emulsion was treated with the French Press for 5 cycles at 800 bar.

### Results:

Visual inspection: the emulsion looks homogeneous, no sign of precipitation of drug substance, no sign of phase separation.
Emulsion pH: 5.1
Emulsion osmolality: 274 mmol/kg.

### Example 6

Emulsion with 0.5 mg/ml Compound (A) for oral application in rats were prepared containing 10% soybean oil and 10% MCT

### Composition:

| Substance | Composition | Weight/Volume | |
|---|---|---|---|
| Compound (A) | 0.5 mg/ml | 10.1 | mg |
| Glycerol | 2.5% | 500 | mg |
| Phospholipon 90 G | 3% | 600 | mg |
| Soybean oil | 10% | 2 | g |
| MCT | 10% | 2 | g |
| Water, dest. | 74.5% | ad 20 | ml (14.9 ml) |
| Emulsion | 100% | 20 | ml |

### Preparation of the Emulsion:

a) The Compound (A) was dissolved in the mixture of soybean oil, MCT and Phospholipon 90 G. The mixture was mixed with the magnetic stirrer for 2 hours at 50° C. The Compound (A) could not be seen anymore, the yellowish solution was clear.
b) Glycerol was mixed with 14.9 g water and heated to app. 40° C. This mixture was added to the lipid blend stepwise and mixed with the Ultraturrax for 5 min. at 9500 rpm
c) The emulsion was treated with the French Press for 5 cycles at 800 bar.

### Results:

Visual inspection: the emulsion looks homogeneous, no sign of precipitation of drug substance, no sign of phase separation.
particle size distribution with Horiba: D90<544 nm
Emulsion pH: 6.2
Emulsion osmolality: 347 mmol/kg.

### Example 7

Emulsion with 0.5 mg/ml Compound (A) for parenteral application in rats were prepared containing 10% soybean oil and 10% MCT

### Composition:

| Substance | Composition | Weight/Volume | |
|---|---|---|---|
| Compound (A) | 0.5 mg/ml | 10 | mg |
| Glycerol | 2.5% | 500 | mg |
| Phospholipon 90 G | 3% | 600 | mg |
| Soybean oil | 10% | 2 | g |
| MCT | 10% | 2 | g |
| Water, dest. | 74.5% | ad 20 | ml (14.9 ml) |
| Emulsion | 100% | 20 | ml |

### Preparation of the Emulsion:

a) The Compound (A) was dissolved in the mixture of soybean oil, MCT and Phospholipon 90 G. The mixture was mixed with the magnetic stirrer for 2 hours at 50° C. The substance could not be seen anymore, the yellowish solution was clear.
b) Glycerol was mixed with 14.9 g water and heated to app. 40° C. This mixture was added to the lipid blend stepwise and mixed with the Ultraturrax for 5 minutes at 9500 rpm
c) The emulsion was treated with the French Press for 5 cycles at 800 bar.

### Results:

Visual inspection: the emulsion looks homogeneous, no sign of precipitation of drug substance, no sign of phase separation.
Particle size distribution with Horiba: D90<648 nm
Emulsion pH: 5.3
Emulsion osmolality: 318 mmol/kg.

### Example 8

Emulsion with 1 mg/ml Compound (A) for parenteral application in monkeys were prepared, containing 10% soybean oil and 10% MCT

### Composition:

| Substance | Composition | Weight/Volume | |
|---|---|---|---|
| Compound (A) | 1 mg/ml | 39.8 | mg |
| Glycerol | 2.5% | 1000 | mg |
| Phospholipon 90 G | 3% | 1200 | mg |
| Soybean oil | 10% | 4 | g |
| MCT | 10% | 4 | g |
| Water, dest. | 74.5% | ad 40 | ml (29.76 ml) |
| Emulsion | 100% | 40 | ml |

### Preparation of the Emulsion:

a) The Compound (A) was dissolved in the mixture of soybean oil, MCT and Phospholipon 90 G. The mixture was mixed with the magnetic stirrer for 0.5 hours at 60° C. The Compound (A) could not be seen anymore, the yellowish solution was clear.
b) Glycerol was mixed with 14.9 g water and heated to app. 40° C. This mixture was added to the lipid blend stepwise and mixed with the Ultraturrax for 5 minutes at 9500 rpm
c) The emulsion was treated with the French Press for 6 cycles at 800 bar.

### Results:

Visual inspection: the emulsion looks homogeneous, no sign of precipitation of drug substance, no sign of phase separation.
Particle size distribution with Horiba: D90<1166 nm.

### Example 9

For long-term stability testing, a large quantity of an emulsion (100 liters with 1 mg/ml Compound (A) for parenteral application) was prepared, containing:
10 kg soybean oil
10 kg MCT
2.5 kg glycerol
1.2 kg egg lecithin
0.03 kg oleic acid
Sodium hydroxide solution (ad pH 7.5)
Water (ad 100 kg).

The following process steps were applied:
A) Water was heated to 55° to 70° C.,
   glycerol was added;
   lecithin and oleic acid were added and homogenised with Ultra-Turrax,
   finally sodium hydroxide solution was added to adjust the pH;
B) MCT and soybean oil are mixed and heated to 55-70° C.
   Compound (A) is added with continued heating and stirring;
C) Composition B) is filtered and then introduced into Composition A),
   mixing with Ultra-Turrax to obtain pre-emulsion;
D) Up to 4 high pressure homogenization steps using 100 to 400 bar are applied,
   then cooling of the emulsion to 25° C. is performed, final adjustment of the pH and volume adaptation with purified water are done.

The emulsion (pH about 7.5; particle size of the oily phase about 240 nm) obtained was stored at different temperatures in glass bottles and observed over a period of 12 months with analysis after 1, 3, 6, 9 and 12 months. Different humidities were tested, e.g. 60% r.h.

The aim of the study was to investigate and assess the pharmaceutical stability of an emulsion formulation containing 1 mg/ml of the pyrazolopyrimidine (Compound A). The current ICH Guideline Q1A on ‘Stability testing of new substances and products’ and information in the paper ‘Stability testing, APV Workshop’ by Grimm et al. (2001) were the basis for the design of this stability study.

The emulsion was filled in 50 mL clear glass bottles of hydrolytic class 2, which were closed with red brom-butyl stoppers and aluminum caps. The samples were stored in a refrigerator at 5° C., under long term storage conditions at 25° C./60% r.h., under accelerated storage conditions at 40° C./75% r.h. and at 60° C. The main results are summarized as follows:

The emulsion was stable for 12 months. A slight decrease of PH and content was observed with increasing temperatures.
At 5° C. nearly complete stability (93% content of active compound) of the emulsion of compound (A) was found after 12 month, the pH very slightly decreased.
At 25° C./60% r.h., very good stability (93% content of active compound) of the emulsion of compound (A) was found after 12 month, the pH very slightly decreased.
At 40° C./75% r.h., very good stability (92% content of active compound) of the emulsion of compound (A) was found after 9 month, the pH-decreased.
At 60° C., good stability (89% content of active compound) of the emulsion of compound (A) was found after 9 month, the pH-decreased.

1. A stencil for printing a pattern of deposits on a substrate, wherein the stencil comprises an electroformed metal sheet which has a first layer which includes an apertured region through which a printing medium is applied in a printing operation, and a second layer which overlies a substrate to be printed and includes a plurality of apertures, wherein the apertures of the second layer extend across and beyond the apertured region in the first layer, whereby the second layer includes a plurality of through apertures in registration with the apertured region of the first layer, each having a pattern corresponding to that to be printed on the substrate, and a plurality of blind apertures disposed adjacent and outwardly of the apertured region in the first layer.

2. The stencil of claim 1, wherein the metal sheet is formed of nickel or a nickel alloy.

3. The stencil of claim 1, wherein the layers of the stencil are integrally formed.

4-5. (canceled)

6. The stencil of claim 1, wherein the apertured region corresponds in shape and size to the substrate to be printed, optionally the apertured region is circular in shade.

7. (canceled)

8. The stencil of claim 1, wherein the apertured region has the form of a grid which comprises orthogonally-arranged web elements, which together define apertures therebetween, optionally the apertures of the first layer are rectangular.

9. (canceled)

10. The stencil of claim 8, wherein the web elements of the first layer have a width of from about 10 μm to about 120 μm, from about 20 pm to about 110 μm, from about 30 μm to about 100 μm about 30 μm or about 100 μm.

11. The stencil of claim 10, wherein the web elements of the first layer have a width of from about 10 μm to about 40 μm, from about 20 μm to about 40 μm or about 30 μm.

12. The stencil of claim 10, wherein the web elements of the first layer have a width of from about 80 μm to about 120 μm, from about 90 μm to about 110 μm or about 100 μm.

13. The stencil of claim 1, wherein the apertures of the first layer have an area of at least about 0.001 mm², from about 0.001 mm² to about 1 mm², at least about 0.0015 mm², from about 0.0015 mm² to about 1 mm², at least about 0.0025 mm², from about 0.0025 mm² to about 1 mm² or not more than about 0.25 mm².

14. The stencil of claim 1, wherein the apertures of the first layer have side lengths of at least about 50 μm, at least about 100 μm, at least about 250 μm or not more than about 1 mm.

15. The stencil of claim 1, wherein the first layer has a thickness of from about 10 μm to about 120 μm, from about 20 μm to about 110 μm, from about 30 μm to about 100 μm about 30 μm or about 100 μm.

16. The stencil of claim 15, wherein the first layer has a thickness of from about 20 μm to about 60 μm, from about 20 μm to about 50 μm, from about 25 μm to about 35 μm or about 30 μm.

17. The stencil of claim 15, wherein the first layer has a thickness of from about 80 μm to about 120 μm, from about 90 μm to about 110 μm or about 100 μm.

18. The stencil of claim 1, wherein the apertures in the second layer each have a substantially square form, separated by orthogonally-arranged web elements.

19. The stencil of claim 18, wherein the web elements of the second layer have a width of from about 100 μm to about 200 μm or from about 100 μm to about 150 μm.

20. The stencil of claim 1, wherein the apertures in the second layer are arranged in the form of a regular array, optionally the apertures in the second layer repeat laterally outwardly beyond the aperture region of the first layer.

21. (canceled)

22. The stencil of claim 1, wherein the apertures of the second layer extend laterally beyond the apertured region of the first layer by a distance of at least about 2 mm, from about 2 mm to about 30 mm, from about 2 mm to about 20 mm, at least about 5 mm, from about 5 mm to about 20 mm or from about 5 mm to about 10 mm.

23-24. (canceled)

25. A method of printing substrates with a pattern of deposits using the stencil of claim 1, optionally the method is for printing deposits of a phosphor or a down-conversion phosphor on the substrate.

26-31. (canceled)

32. The stencil of claim 1, wherein the layers are formed of the same material or different materials.

33. The stencil of claim 1, wherein the substrate is (a) a wafer, a silicon wafer or a sapphire wafer, or (b) a transfer carrier for transferring the prints to a wafer, a silicon wafer or a sapphire wafer.

34. The method of claim 25, comprising the steps of:
providing a substrate;
providing the stencil of claim 1 over the substrate;
applying print medium over the stencil, such that the print medium is forced through the apertures in the second layer and a pattern of deposits is printed on the substrate corresponding to the pattern of through apertures in the second layer of the stencil.

35. The method of claim 34, wherein the substrate is a wafer, and the deposits are printed directly onto dies formed in the wafer without any intermediate transfer steps.

36. A method of fabricating a light-emitting device, comprising the steps of:
performing the printing step of claim 35; and
separating the printed dies of the wafer.

37. The method of claim 36, wherein at least 90% of the printed dies of the wafer are selected, and further comprising the step of:
providing each of the selected dies in device packaging to provide light-emitting devices.

38. The method of claim 37, wherein the deposits on the selected dies of the wafer are not subjected to any surface thickness processing.
